(19) United States
(12) Patent Application Publication
(10) Pub. No.: US 2012/0269275 A1
(43) Pub. Date: Oct. 25, 2012

(54) Method and device for video coding and decoding

(75) Inventor: Miska Matias Hannuksela, Ruutana (FI)

(73) Assignee: NOKIA CORPORATION, Espoo (FI)

(21) Appl. No.: 13/277,831

(22) Filed: Oct. 20, 2011

Related U.S. Application Data
(60) Provisional application No. 61/405,159, filed on Oct. 20, 2010.

(51) Int. Cl. H04N 7/12

(52) U.S. Cl. 375/240.25; 375/240.01; 375/E07.027; 375/E07.026

(57) ABSTRACT

There is disclosed a method for encoding at least two views of a video scene into a multiview video bitstream, where said views have different spatial resolutions. The method comprises prediction between pictures belonging to different views after resampling of one of these pictures. There is also disclosed a method for decoding a multiview video bitstream comprising at least two views having different spatial resolutions. The method comprises prediction between pictures belonging to different views after resampling of one of these pictures. There are also disclosed corresponding apparatuses and computer program products.

### RELATED APPLICATION

This application claims the benefit of U.S. Provisional Application No. 61/405,159, filed Oct. 20, 2010, the content of which is incorporated herein by reference in its entirety.

### TECHNICAL FIELD

This invention relates to video coding and decoding. In particular, the present invention relates to the use of scalable video coding for different views of multiview video coding content.

### BACKGROUND INFORMATION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

In order to facilitate communication of video content over one or more networks, several coding standards have been developed. Video coding standards include ITU-T H.261, ISO/IEC MPEG-1 Video, ITU-T H.262 or ISO/IEC MPEG-2 Video, ITU-T H.263, ISO/IEC MPEG-4 Visual, ITU-T H.264 (also know as ISO/IEC MPEG-4 AVC), the scalable video coding (SVC) extension of H.264/AVC, and the multiview video coding (MVC) extension of H.264/AVC. In addition, there are currently efforts underway to develop new video coding standards.

In scalable video coding, a video signal can be encoded into a base layer and one or more enhancement layers constructed. An enhancement layer enhances the temporal resolution (i.e., the frame rate), the spatial resolution, or simply the quality of the video content represented by another layer or part thereof. Each layer together with all its dependent layers is one representation of the video signal at a certain spatial resolution, temporal resolution and quality level. In this document, we refer to a scalable layer together with all of its dependent layers as a “scalable layer representation”. The portion of a scalable bitstream corresponding to a scalable layer representation can be extracted and decoded to produce a representation of the original signal at certain fidelity.

Compressed multi-view video sequences require a considerable bitrate. They may have been coded for a spatial resolution (picture size in terms of pixels) or picture quality (spatial details) that are unnecessary for a display in use or unfeasible for a computational capacity in use while being suitable for another display and another computational complexity in use. In many systems, it would therefore be desirable to adjust the transmitted or processed bitrate, the picture rate, the picture size, or the picture quality of a compressed multi-view video bitstream. The current multi-view video coding solutions offer scalability only in terms of view scalability (selecting which views are decoded) or temporal scalability (selecting the picture rate at which the sequence is decoded.

The multi-view video profile of MPEG-2 video enables stereoscopic (2-view) video coded as if views were layers of a scalable MPEG-2 video bitstream, where a base layer is assigned to a left view and an enhancement layer is assigned to a right view. The multi-view video extension of H.264/AVC has been built on top of H.264/AVC, which provides only temporal scalability.

One branch of research in stereoscopic video compression is known as mixed-resolution (MR) stereoscopic video coding. In MR stereoscopic video, one of the two views is represented with a lower resolution compared to the other one, while, according to the binocular vision theory, it is assumed that the Human Visual System (HVS) fuses the two images such that the perceived quality is close to that of the higher quality view. In one study, the breakdown point where the higher-resolution view was no longer dominant in the perceived quality seemed to be between 11.4 and 7.6 pixels per degree of viewing angle.

Two asymmetric multiview video coding schemes have been presented: a quality asymmetry achieved with Medium Grain Scalability (MGS) or Fine Grain Scalability (FGS), and a spatially scalable mixed-resolution bitstream. In the latter scheme, equivalent layers in different views are of different resolutions and the equivalent layers have to be pruned jointly. For example, there are two views, view 0 and view 1, both having a base layer and one spatial enhancement layer. For view 0, the base layer is coded as VGA and the enhancement layer as 4VGA. For view 1, the base layer is coded as QVGA and the enhancement layer as VGA. The encoder uses asymmetric inter-view prediction between the views in both layers. That is, when the enhancement layer of view 1 is decoded, the decoded picture resulting from view 0 (both base and enhancement layers) is downsampled to be used as an inter-view reference. When the base layer of view 1 is decoded (i.e., the enhancement layer is removed from the bitstream), the decoded picture resulting from the base layer of view 0 is downsampled to be used as an inter-view reference. The encoder sets the pruning order indicator of the enhancement layers of both views to be the same. Consequently, a bitstream resulting to decoding of both the base layer and the enhancement layer of view 0 and only base layer of view 1 won't be possible.

Reference Picture Resampling was specified as Annex P of ITU-T Recommendation H.263. The annex describes the use and syntax of a resampling process which can be applied to the previous decoded reference picture in order to generate a “warped” picture for use in predicting the current picture. This resampling syntax can specify the relationship of the current picture to a prior picture having a different source format, and can also specify a “global motion” warping alteration of the shape, size, and location of the prior picture with respect to the current picture. In particular, the Reference Picture Resampling mode can be used to adaptively alter the resolution of pictures during encoding. The Reference Picture Resampling mode can be invoked implicitly by the occurrence of a picture header for an INTER coded picture having a picture size which differs from that of the previous encoded picture.

### SUMMARY

In one aspect, the invention relates to a method for encoding a first uncompressed picture of a first view and a second uncompressed picture of a second view into a bitstream. The method comprises:

encoding a first uncompressed picture;

reconstructing a first decoded picture on the basis of the encoding of the first uncompressed picture;

resampling at least a part of the first decoded picture into a first resampled decoded picture; and

encoding a second uncompressed picture as a first dependency representation and a second dependency representation,

wherein the first resampled decoded picture is used as a prediction reference for the encoding of the first dependency representation;

the first decoded picture is used as a prediction reference for the encoding of the second dependency representation; and

the first dependency representation is used in the encoding of the second dependency representation.

According to a second aspect there is provided an apparatus comprising:

an encoder configured for encoding the first uncompressed picture of a first view;

a reconstructor configured for reconstructing a first decoded picture on the basis of the encoding of the first uncompressed picture;

a sampler configured for resampling at least a part of the first decoded picture into a first resampled decoded picture; and

said encoder being further configured for

encoding a second uncompressed picture as a first dependency representation by using the first resampled decoded picture as a prediction reference, and

encoding a second dependency representation of a second view by using the first decoded picture as a prediction reference and the first dependency representation in the encoding of the second dependency representation.

According to a third aspect there is provided an apparatus comprising:

a processor; and

a memory unit operatively connected to the processor and including:

computer code configured to:

encode a first uncompressed picture of a first view;

reconstruct a first decoded picture on the basis of the encoding of the first uncompressed picture;

resample at least a part of the first decoded picture into a first resampled decoded picture; and

encode a second uncompressed picture of a second view as a first dependency representation and a second dependency representation,

wherein the first resampled decoded picture is used as a prediction reference for the encoding of the first dependency representation;

the first decoded picture is used as a prediction reference for the encoding of the second dependency representation; and

the first dependency representation is used in the encoding of the second dependency representation.

According to a fourth aspect there is provided a method for decoding a multiview video bitstream comprising a first view component of a first view and a second view component of a second view, the method comprising:

decoding the first view component into a first decoded picture;

determining a spatial resolution of the first view component and a spatial resolution of the second view component;

on the basis of the spatial resolution of the first view component being different from the spatial resolution of the second view component:

resampling at least a part of the first decoded picture into a first resampled decoded picture;

decoding the second view component using the first resampled decoded picture as a prediction reference.

According to a fifth aspect there is provided an apparatus comprising:

a decoder configured for decoding a first view component of a first view into a first decoded picture;

a determining element configured for determining a spatial resolution of the first view component being different from a spatial resolution of a second view component of a second view;

a sampler configured for resampling at least a part of the first decoded picture into a first resampled decoded picture when the spatial resolution of the first view component differs from the spatial resolution of the second view component; and

said decoder being further configured for decoding the second view component using the first resampled decoded picture as a prediction reference.

According to a sixth aspect there is provided an apparatus comprising:

a processor; and

a memory unit operatively connected to the processor and including

computer code configured to:

decode the first view component of a first view into a first decoded picture;

determine a spatial resolution of the first view component and a spatial resolution of a second view component of a second view;

on the basis of the spatial resolution of the first view component being different from the spatial resolution of the second view component:

resample at least a part of the first decoded picture into a first resampled decoded picture;

decode the second view component using the first resampled decoded picture as a prediction reference.

According to a seventh aspect there is provided a computer readable storage medium stored with code thereon for use by an apparatus, which when executed by a processor, causes the apparatus to perform:

encode a first uncompressed picture of a first view;

reconstruct a first decoded picture on the basis of the encoding of the first uncompressed picture;

resample at least a part of the first decoded picture into a first resampled decoded picture; and

encode a second uncompressed picture of a second view as a first dependency representation and a second dependency representation,

wherein the code, which when executed by a processor, further causes the apparatus to:

use the first resampled decoded picture as a prediction reference for the encoding of the first dependency representation;

use the first decoded picture as a prediction reference for the encoding of the second dependency representation; and

use the first dependency representation in the encoding of the second dependency representation.

According to an eighth aspect there is provided a computer readable storage medium stored with code thereon for use by an apparatus, which when executed by a processor, causes the apparatus to perform:

decode a first view component of a first view into a first decoded picture;

determine a spatial resolution of the first view component and a spatial resolution of a second view component of a second view;

on the basis of the spatial resolution of the first view component being different from the spatial resolution of the second view component:

resample at least a part of the first decoded picture into a first resampled decoded picture;

decode the second view component using the first resampled decoded picture as a prediction reference.

According to a ninth aspect there is provided at least one processor and at least one memory, said at least one memory stored with code thereon, which when executed by said at least one processor, causes an apparatus to perform:

encode the first uncompressed picture of a first view;

reconstruct a first decoded picture on the basis of the encoding of the first uncompressed picture;

resample at least a part of the first decoded picture into a first resampled decoded picture; and

encode a second uncompressed picture of a second view as a first dependency representation and a second dependency representation,

wherein the code, which when executed by a processor, further causes the apparatus to:

use the first resampled decoded picture as a prediction reference for the encoding of the first dependency representation;

use the first decoded picture as a prediction reference for the encoding of the second dependency representation; and

use the first dependency representation in the encoding of the second dependency representation.

According to a tenth aspect there is provided at least one processor and at least one memory, said at least one memory stored with code thereon, which when executed by said at least one processor, causes an apparatus to perform:

decode a first view component of a first view into a first decoded picture;

determine a spatial resolution of the first view component and a spatial resolution of a second view component of a second view;

on the basis of the spatial resolution of the first view component being different from the spatial resolution of the second view component:

resample at least a part of the first decoded picture into a first resampled decoded picture;

decode the second view component using the first resampled decoded picture as a prediction reference.

According to an eleventh aspect there is provided an apparatus comprising:

means for encoding a first uncompressed picture of a first view;

means for reconstructing a first decoded picture on the basis of the encoding of the first uncompressed picture;

means for resampling at least a part of the first decoded picture into a first resampled decoded picture; and

means for encoding a second uncompressed picture of a second view as a first dependency representation by using the first resampled decoded picture as a prediction reference, and

means for encoding a second dependency representation by using the first decoded picture as a prediction reference and the first dependency representation in the encoding of the second dependency representation.

According to a twelfth aspect there is provided an apparatus comprising:

means for decoding a first view component of a first view into a first decoded picture;

means for determining a spatial resolution of the first view component being different from a spatial resolution of a second view component of a second view;

means for resampling at least a part of the first decoded picture into a first resampled decoded picture when the spatial resolution of the first view component differs from the spatial resolution of the second view component; and

means for decoding the second view component using the first resampled decoded picture as a prediction reference.

In some embodiments a scalable coding of multiview video bitstreams is implemented in such a manner that scalable layers can be pruned unevenly between views. For example, the base view may be non-scalably coded, while the non-base view is spatially scalably coded. The inter-view prediction from the base view is adapted on the basis of which scalable layers are present in the non-base view.

The capability or preference of receivers to decode full-resolution or mixed-resolution video may not be known at the time of encoding or there are receivers of both type receiving the same bitstream. A full-resolution symmetric stereo video bitstream may be adapted in a gateway to become a mixed-resolution bitstream to meet receiver's capabilities/preferences and/or downlink network throughput.

Services or transmission schemes falling under these constraints include the following:

Multiparty video conferencing with heterogeneous receivers or network capability. A multipoint conference control unit (MCU) adapts the bitstream according to downlink throughput and/or receiver capabilities/preferences.

IP multicast. The base and enhancement layers of the non-base view are transmitted in distinct multicast groups, and receivers may subscribe to only the base layer or both layers.

Application-layer multicast (a.k.a. peer-to-peer streaming). Each relay node forwards the bitstream according to downlink throughput and/or receiver capabilities/preferences.

Broadcast. Some receivers might decode mixed-resolution stereo video as opposed to full-resolution symmetric stereo video in order to save computational resources.

Local file playback. At the time of generating the file, the computational capability of the player device is not known.

In some embodiments the receiver's preference for receiving mixed-resolution stereo video bitstream may be based on the analysis of viewer distance from the display.

### DESCRIPTION OF THE DRAWINGS

Embodiments of the invention are described by referring to the attached drawings, in which:

FIG. 1 illustrates an exemplary hierarchical coding structure with temporal scalability;

FIG. 2 illustrates an exemplary MVC decoding order;

FIG. 3 illustrates an exemplary MVC prediction structure for multi-view video coding;

FIG. 4 is an overview diagram of a system within which various embodiments of the present invention may be implemented;

FIG. 5 illustrates a perspective view of an exemplary electronic device which may be utilized in accordance with the various embodiments of the present invention;

FIG. 6 is a schematic representation of the circuitry which may be included in the electronic device of FIG. 5;

FIG. 7 is a graphical representation of a generic multimedia communication system within which various embodiments may be implemented;

FIG. 8 illustrates an example of a scalable stereoscopic coding scheme enabling bitstream pruning to a mixed-resolution stereoscopic video;

FIG. 9 illustrates a modified inter-view prediction when encoding or decoding mixed-resolution stereoscopic video;

FIG. 10 is a flow diagram of an encoding method according to an example embodiment of the present invention;

FIG. 11 is a flow diagram of a decoding method according to an example embodiment of the present invention; and

FIG. 12 is a schematic representation of a converter according to an example embodiment of the present invention.

### DETAILED DESCRIPTION OF SOME EXAMPLE EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

As noted above, in scalable video coding, a video signal can be encoded into a base layer and one or more enhancement layers constructed. An enhancement layer enhances the temporal resolution (i.e., the frame rate), the spatial resolution, or simply the quality of the video content represented by another layer or part thereof. Each layer together with all its dependent layers is one representation of the video signal at a certain spatial resolution, temporal resolution and quality level. In this document, we refer to a scalable layer together with all of its dependent layers as a “scalable layer representation”. The portion of a scalable bitstream corresponding to a scalable layer representation can be extracted and decoded to produce a representation of the original signal at certain fidelity.

In some cases, data in an enhancement layer can be truncated after a certain location, or even at arbitrary positions, where each truncation position may include additional data representing increasingly enhanced visual quality. Such scalability is referred to as fine-grained (granularity) scalability (FGS). FGS was included in some draft versions of the SVC standard, but it was eventually excluded from the final SVC standard. FGS is subsequently discussed in the context of some draft versions of the SVC standard. The scalability provided by those enhancement layers that cannot be truncated is referred to as coarse-grained (granularity) scalability (CGS). It collectively includes the traditional quality (SNR) scalability and spatial scalability. The SVC standard supports the so-called medium-grained scalability (MGS), where quality enhancement pictures are coded similarly to SNR scalable layer pictures but indicated by high-level syntax elements similarly to FGS layer pictures, by having the quality_id syntax element greater than 0.

SVC uses an inter-layer prediction mechanism, wherein certain information can be predicted from layers other than the currently reconstructed layer or the next lower layer. Information that could be inter-layer predicted includes intra texture, motion and residual data. Inter-layer motion prediction includes the prediction of block coding mode, header information, etc., wherein motion from the lower layer may be used for prediction of the higher layer. In case of intra coding, a prediction from surrounding macroblocks or from co-located macroblocks of lower layers is possible. These prediction techniques do not employ information from earlier coded access units and hence, are referred to as intra prediction techniques. Furthermore, residual data from lower layers can also be employed for prediction of the current layer.

SVC specifies a concept known as single-loop decoding. It is enabled by using a constrained intra texture prediction mode, whereby the inter-layer intra texture prediction can be applied to macroblocks (MBs) for which the corresponding block of the base layer is located inside intra-MBs. At the same time, those intra-MBs in the base layer use constrained intra-prediction (e.g., having the syntax element “constrained_intra_pred_flag” equal to 1). In single-loop decoding, the decoder performs motion compensation and full picture reconstruction only for the scalable layer desired for playback (called the “desired layer” or the “target layer”), thereby greatly reducing decoding complexity. All of the layers other than the desired layer do not need to be fully decoded because all or part of the data of the MBs not used for inter-layer prediction (be it inter-layer intra texture prediction, inter-layer motion prediction or inter-layer residual prediction) is not needed for reconstruction of the desired layer.

A single decoding loop is needed for decoding of most pictures, while a second decoding loop is selectively applied to reconstruct the base representations, which are needed as prediction references but not for output or display, and are reconstructed only for the so called key pictures (for which “store_ref_base_pic_flag” is equal to 1).

The scalability structure in the SVC draft is characterized by three syntax elements: “temporal_id,” “dependency_id” and “quality_id.” The syntax element “temporal_id” is used to indicate the temporal scalability hierarchy or, indirectly, the frame rate. A scalable layer representation comprising pictures of a smaller maximum “temporal_id” value has a smaller frame rate than a scalable layer representation comprising pictures of a greater maximum “temporal_id”. A given temporal layer typically depends on the lower temporal layers (i.e., the temporal layers with smaller “temporal_id” values) but does not depend on any higher temporal layer. The syntax element “dependency_id” is used to indicate the CGS inter-layer coding dependency hierarchy (which, as mentioned earlier, includes both SNR and spatial scalability). At any temporal level location, a picture of a smaller “dependency_id” value may be used for inter-layer prediction for coding of a picture with a greater “dependency_id” value. The syntax element “quality_id” is used to indicate the quality level hierarchy of a FGS or MGS layer. At any temporal location, and with an identical “dependency_id” value, a picture with “quality_id” equal to QL uses the picture with “quality_id” equal to QL−1 for inter-layer prediction. A coded slice with “quality_id” larger than 0 may be coded as either a truncatable FGS slice or a non-truncatable MGS slice.

For simplicity, all the data units (e.g., Network Abstraction Layer units or NAL units in the SVC context) in one access unit having identical value of “dependency_id” are referred to as a dependency unit or a dependency representation. Within one dependency unit, all the data units having identical value of “quality_id” are referred to as a quality unit or layer representation.

A base representation, also known as a decoded base picture, is a decoded picture resulting from decoding the Video Coding Layer (VCL) NAL units of a dependency unit having “quality_id” equal to 0 and for which the “store_ref_base_pic_flag” is set equal to 1. An enhancement representation, also referred to as a decoded picture, results from the regular decoding process in which all the layer representations that are present for the highest dependency representation are decoded.

Each H.264/AVC VCL NAL unit (with NAL unit type in the scope of 1 to 5) is preceded by a prefix NAL unit in an SVC bitstream. A compliant H.264/AVC decoder implementation ignores prefix NAL units. The prefix NAL unit includes the “temporal_id” value and hence an SVC decoder, that decodes the base layer, can learn from the prefix NAL units the temporal scalability hierarchy. Moreover, the prefix NAL unit includes reference picture marking commands for base representations.

SVC uses the same mechanism as H.264/AVC to provide temporal scalability. Temporal scalability provides refinement of the video quality in the temporal domain, by giving flexibility of adjusting the frame rate. A review of temporal scalability is provided in the subsequent paragraphs.

The earliest scalability introduced to video coding standards was temporal scalability with B pictures in MPEG-1 Visual. In this B picture concept, a B picture is bi-predicted from two pictures, one preceding the B picture and the other succeeding the B picture, both in display order. In bi-prediction, two prediction blocks from two reference pictures are averaged sample-wise to get the final prediction block. Conventionally, a B picture is a non-reference picture (i.e., it is not used for inter picture prediction reference by other pictures). Consequently, the B pictures could be discarded to achieve a temporal scalability point with a lower frame rate. The same mechanism was retained in MPEG-2 Video, H.263 and MPEG-4 Visual.

In H.264/AVC, the concept of B pictures or B slices has been changed. The definition of B slice is as follows: A slice that may be decoded using intra prediction from decoded samples within the same slice or inter prediction from previously decoded reference pictures, using at most two motion vectors and reference indices to predict the sample values of each block. Both the bi-directional prediction property and the non-reference picture property of the conventional B picture concept are no longer valid. A block in a B slice may be predicted from two reference pictures in the same direction in display order, and a picture consisting of B slices may be referred by other pictures for inter-picture prediction.

In H.264/AVC, SVC and MVC, temporal scalability can be achieved by using non-reference pictures and/or hierarchical inter-picture prediction structure. Using only non-reference pictures is able to achieve similar temporal scalability as using conventional B pictures in MPEG-1/2/4, by discarding non-reference pictures. Hierarchical coding structure can achieve more flexible temporal scalability.

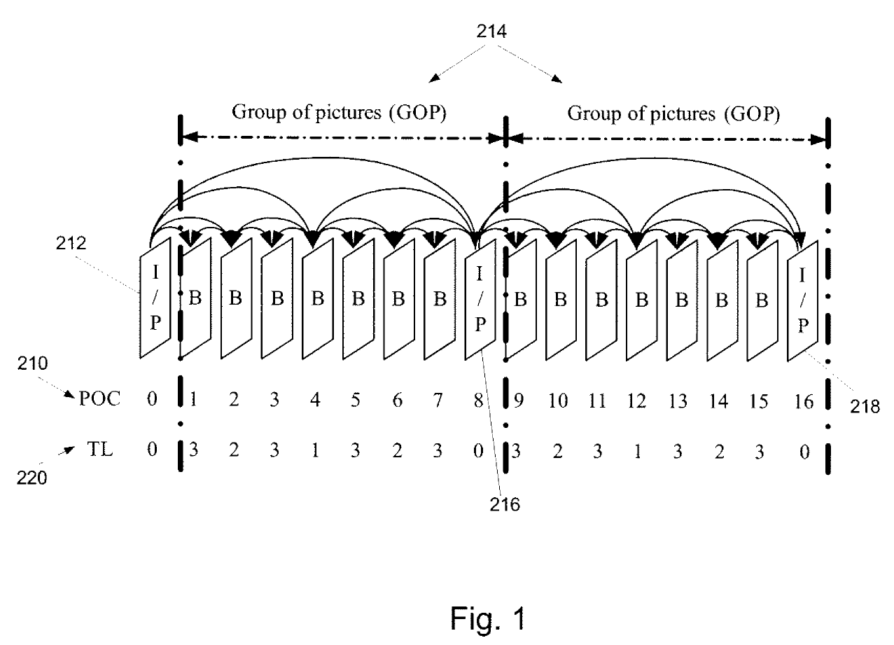

Referring now to FIG. 1, an exemplary hierarchical coding structure is illustrated with four levels of temporal scalability. The display order is indicated by the values denoted as picture order count (POC) 210. The I or P pictures, such as I/P picture 212, also referred to as key pictures, are coded as the first picture of a group of pictures (GOPs) 214 in decoding order. When a key picture (e.g., key picture 216, 218) is inter-coded, the previous key pictures 212, 216 are used as reference for inter-picture prediction. These pictures correspond to the lowest temporal level 220 (denoted as TL in the figure) in the temporal scalable structure and are associated with the lowest frame rate. Pictures of a higher temporal level may only use pictures of the same or lower temporal level for inter-picture prediction. With such a hierarchical coding structure, different temporal scalability corresponding to different frame rates can be achieved by discarding pictures of a certain temporal level value and beyond. In FIG. 1, the pictures 0, 8 and 16 are of the lowest temporal level, while the pictures 1, 3, 5, 7, 9, 11, 13 and 15 are of the highest temporal level. Other pictures are assigned with other temporal level hierarchically. These pictures of different temporal levels compose the bitstream of different frame rate. When decoding all the temporal levels, a frame rate of 30 Hz is obtained. Other frame rates can be obtained by discarding pictures of some temporal levels. The pictures of the lowest temporal level are associated with the frame rate of 3.25 Hz. A temporal scalable layer with a lower temporal level or a lower frame rate is also called as a lower temporal layer.

The above-described hierarchical B picture coding structure is the most typical coding structure for temporal scalability. However, it is noted that much more flexible coding structures are possible. For example, the GOP size may not be constant over time. In another example, the temporal enhancement layer pictures do not have to be coded as B slices; they may also be coded as P slices.

In H.264/AVC, the temporal level may be signaled by the sub-sequence layer number in the sub-sequence information Supplemental Enhancement Information (SEI) messages. In SVC, the temporal level is signaled in the Network Abstraction Layer (NAL) unit header by the syntax element “temporal_id.” The bitrate and frame rate information for each temporal level is signaled in the scalability information SEI message.

As mentioned earlier, CGS includes both spatial scalability and SNR scalability. Spatial scalability is initially designed to support representations of video with different resolutions. For each time instance, VCL NAL units are coded in the same access unit and these VCL NAL units can correspond to different resolutions. During the decoding, a low resolution VCL NAL unit provides the motion field and residual which can be optionally inherited by the final decoding and reconstruction of the high resolution picture. When compared to older video compression standards, SVC's spatial scalability has been generalized to enable the base layer to be a cropped and zoomed version of the enhancement layer.

MGS quality layers are indicated with “quality_id” similarly as FGS quality layers. For each dependency unit (with the same “dependency_id”), there is a layer with “quality_id” equal to 0 and can be other layers with “quality_id” greater than 0. These layers with “quality_id” greater than 0 are either MGS layers or FGS layers, depending on whether the slices are coded as truncatable slices.

In the basic form of FGS enhancement layers, only inter-layer prediction is used. Therefore, FGS enhancement layers can be truncated freely without causing any error propagation in the decoded sequence. However, the basic form of FGS suffers from low compression efficiency. This issue arises because only low-quality pictures are used for inter prediction references. It has therefore been proposed that FGS-enhanced pictures be used as inter prediction references. However, this causes encoding-decoding mismatch, also referred to as drift, when some FGS data are discarded.

One feature of SVC is that the FGS NAL units can be freely dropped or truncated, and MGS NAL units can be freely dropped (but cannot be truncated) without affecting the conformance of the bitstream. As discussed above, when those FGS or MGS data have been used for inter prediction reference during encoding, dropping or truncation of the data would result in a mismatch between the decoded pictures in the decoder side and in the encoder side. This mismatch is also referred to as drift.

To control drift due to the dropping or truncation of FGS or MGS data, SVC applied the following solution: In a certain dependency unit, a base representation (by decoding only the CGS picture with “quality_id” equal to 0 and all the dependent-on lower layer data) is stored in the decoded picture buffer. When encoding a subsequent dependency unit with the same value of “dependency_id,” all of the NAL units, including FGS or MGS NAL units, use the base representation for inter prediction reference. Consequently, all drift due to dropping or truncation of FGS or MGS NAL units in an earlier access unit is stopped at this access unit. For other dependency units with the same value of “dependency_id,” all of the NAL units use the decoded pictures for inter prediction reference, for high coding efficiency.

Each NAL unit includes in the NAL unit header a syntax element “use_ref_base_pic_flag.” When the value of this element is equal to 1, decoding of the NAL unit uses the base representations of the reference pictures during the inter prediction process. The syntax element “store_ref_base_pic_flag” specifies whether (when equal to 1) or not (when equal to 0) to store the base representation of the current picture for future pictures to use for inter prediction.

NAL units with “quality_id” greater than 0 do not contain syntax elements related to reference picture lists construction and weighted prediction, i.e., the syntax elements “num_ref_active_lx_minus1” (x=0 or 1), the reference picture list reordering syntax table, and the weighted prediction syntax table are not present. Consequently, the MGS or FGS layers have to inherit these syntax elements from the NAL units with “quality_id” equal to 0 of the same dependency unit when needed.

The leaky prediction technique makes use of both base representations and decoded pictures (corresponding to the highest decoded “quality_id”), by predicting FGS data using a weighted combination of the base representations and decoded pictures. The weighting factor can be used to control the attenuation of the potential drift in the enhancement layer pictures. More information on leaky prediction can be found in H. C. Huang, C. N. Wang, and T. Chiang, “A robust fine granularity scalability using trellis-based predictive leak,” IEEE Trans. Circuits Syst. Video Technol., vol. 12, no. 6, pp. 372-385, June 2002.

When leaky prediction is used, the FGS feature of the SVC is often referred to as Adaptive Reference FGS (AR-FGS). AR-FGS is a tool to balance between coding efficiency and drift control. AR-FGS enables leaky prediction by slice level signaling and MB level adaptation of weighting factors. More details of a mature version of AR-FGS can be found in JVT-W119: Yiliang Bao, Marta Karczewicz, Yan Ye “CE1 report: FGS simplification,” JVT-W119, 23rd JVT meeting, San Jose, USA, April 27, available at ftp3.itu.ch/av-arch/jvt-site/27_{—}04_SanJose/JVT-W119.zip.

A value of picture order count (POC) is derived for each picture and is non-decreasing with increasing picture position in output order relative to the previous IDR picture or a picture containing a memory management control operation marking all pictures as “unused for reference.” POC therefore indicates the output order of pictures. POC is also used in the decoding process for implicit scaling of motion vectors in the temporal direct mode of bi-predictive slices, for implicitly derived weights in weighted prediction, and for reference picture list initialization of B slices. Furthermore, POC is used in verification of output order conformance.

Values of POC can be coded with one of the three modes signaled in the active sequence parameter set. In the first mode, the selected number of least significant bits of the POC value is included in each slice header. It may be beneficial to use the first mode when the decoding and output order of pictures differs and the picture rate varies. In the second mode, the relative increments of POC as a function of the picture position in decoding order in the coded video sequence are coded in the sequence parameter set. In addition, deviations from the POC value derived from the sequence parameter set may be indicated in slice headers. The second mode suits bitstreams in which the decoding and output order of pictures differs and the picture rate stays exactly or close to unchanged. In the third mode, the value of POC is derived from the decoding order by assuming that the decoding and output order are identical. In addition, only one non-reference picture can occur consecutively, when the third mode is used.

The reference picture lists construction in AVC can be described as follows. When multiple reference pictures can be used, each reference picture must be identified. In AVC, the identification of a reference picture used for a coded block is as follows. First, all of the reference pictures stored in the DPB for prediction reference of future pictures is either marked as “used for short-term reference” (referred to as short-term pictures) or “used for long-term reference” (referred to as long-term pictures). When decoding a coded slice, a reference picture list is constructed. If the coded slice is a bi-predicted slice, a second reference picture list is also constructed. A reference picture used for a coded block is then identified by the index of the used reference picture in the reference picture list. The index is coded in the bitstream when more than one reference picture may be used.

The reference picture list construction process is as follows. For simplicity, it is assumed herein that only one reference picture list is needed. First, an initial reference picture list is constructed including all of the short-term and long-term reference pictures. Reference picture list reordering (RPLR) is then performed when the slice header contains RPLR commands. The RPLR process may reorder the reference pictures into a different order than the order in the initial list. Both the initial list and the final list, after reordering, contains only a certain number of entries indicated by a syntax element in the slice header or the picture parameter set referred by the slice.

During the initialization process, all of the short-term and long-term pictures are considered as candidates of reference picture lists for the current picture. No matter current picture is B or P picture, and long-term pictures are placed after the short-term pictures in RefPicList0 (and RefPicList1 available for B slices). For P pictures, the initial reference picture list for RefPicList0 contains all short-term reference pictures ordered in descending order of PicNum.

For B pictures, those reference pictures obtained from all short term pictures are ordered by a rule related to current POC number and the POC number of the reference picture. For RefPicList0, reference pictures with smaller POC (comparing to current POC) are considered first and inserted into the RefPictList0 with the descending order of POC. Pictures with larger POC are then appended with the ascending order of POC. For RefPicList1 (if available), reference pictures with larger POC (comparing to current POC) are considered first and inserted into the RefPicList1 with the ascending order of POC. Pictures with smaller POC are then appended with descending order of POC. After considering all of the short-term reference pictures, the long-term reference pictures are appended by the ascending order of LongTermPicNum, both for P and B pictures.

The reordering process is invoked by continuous RPLR commands, including four type of commands: (1) A command to specify a short-term picture with smaller PicNum (comparing to a temporally predicted PicNum) to be moved; (2) a command to specify a short-term picture with larger PicNum to be moved; (3) a command to specify a long-term picture with a certain LongTermPicNum to be moved and (4) a command to specify the end of the RPLR loop. If a current picture is bi-predicted, there are two loops—one for the forward reference list and one for the backward reference list.

The predicted PicNum referred to as picNumLXPred is initialized as the PicNum of the current coded picture and is set to the PicNum of the just moved picture after each reordering process for a short-term picture. The difference between the PicNum of a current picture being reordered and picNumLXPred is signaled in the RPLR command. The picture indicated to be reordered is moved to the beginning of the reference picture list. After the reordering process is complete, a whole reference picture list is truncated based on the active reference picture list size, which is num_ref idx_{—}1X_active_minus1+1 (X equal to 0 or 1 corresponds for RefPicList0 and RefPicList1 respectively).

In SVC, a reference picture list consists of either only base representations (when “use_ref_base_pic_flag” is equal to 1) or only decoded pictures not marked as “base representation” (when “use_ref_base_pic_flag” is equal to 0), but never both at the same time.

In terms of reference picture marking, decoded pictures used for predicting subsequent coded pictures and for future output are buffered in the decoded picture buffer (DPB). To efficiently utilize the buffer memory, the DPB management processes, including the storage process of decoded pictures into the DPB, the marking process of reference pictures, output and removal processes of decoded pictures from the DPB, are specified.

The process for reference picture marking in AVC is summarized as follows. The maximum number of reference pictures used for inter prediction, referred to as M, is indicated in the active sequence parameter set. When a reference picture is decoded, it is marked as “used for reference.” If the decoding of the reference picture causes more than M pictures to be marked as “used for reference,” at least one picture must be marked as “unused for reference.” The DPB removal process then removes pictures marked as “unused for reference” from the DPB if they are not needed for output as well.

There are two types of operation for the reference picture marking: adaptive memory control and sliding window. The operation mode for reference picture marking is selected on a picture basis. The adaptive memory control requires the presence of memory management control operation (MMCO) commands in the bitstream. The memory management control operations enable explicit signaling which pictures are marked as “unused for reference,” assigning long-term frame indices to short-term reference pictures, storage of the current picture as long-term picture, changing a short-term picture to the long-term picture, and assigning the maximum allowed long-term frame index (MaxLongTermFrameIdx) for long-term pictures. If the sliding window operation mode is in use and there are M pictures marked as “used for reference,” then the short-term reference picture that was first decoded picture among those short-term reference pictures that are marked as “used for reference” is marked as “unused for reference.” In other words, the sliding window operation mode results in first-in-first-out buffering operation among shortterm reference pictures.

Each short-term picture is associated with a variable PicNum that is derived from the syntax element “frame_num,” and each long-term picture is associated with a variable LongTermPicNum that is derived from the “long_term_frame_idx” which is signaled by MMCO command.

PicNum is derived from FrameNumWrap depending on whether frame or field is coded or decoded. For frames where PicNum equal to FrameNumWrap. FrameNumWrap is derived from FrameNum, and FrameNum is derived from frame_num. For example, in AVC frame coding, FrameNum is assigned the same as frame_num and FrameNumWrap is defined as below: if (FrameNum>frame_num) FrameNumWrap=FrameNum−MaxFrameNum else FrameNumWrap=FrameNum.

LongTermPicNum is derived from the long-term frame index (LongTermFrameIdx) assigned for the picture. For frames, LongTermPicNum is equal to LongTermFrameIdx.

“frame_num” is a syntax element in each slice header. The value of “frame_num” for a frame or a complementary field pair essentially increments by one, in modulo arithmetic, relative to the “frame_num” of the previous reference frame or reference complementary field pair. In IDR pictures, the value of “frame_num” is zero. For pictures containing a memory management control operation marking all pictures as “unused for reference,” the value of “frame_num” is considered to be zero after the decoding of the picture.

The MMCO commands use PicNum and LongTermPicNum for indicating the target picture for the command as follows. (1) To mark a short-term picture as “unused for reference,” the PicNum difference between current picture p and the destination picture r is to be signaled in the MMCO command. (2) To mark a long-term picture as “unused for reference,” the LongTermPicNum of the to-be-removed picture r is to be signaled in the MMCO command. (3) To store the current picture p as a long-term picture, a “long_term_frame_idx” is to be signaled with the MMCO command. This index is assigned to the newly stored long-term picture as the value of LongTermPicNum. (4) To change a picture r from short-term picture to long-term picture, a PicNum difference between current picture p and picture r is signaled in the MMCO command and the “long_term_frame_idx” is signaled in the MMCO command. The index is also assigned to the this long-term picture.

In addition to the above reference picture marking concepts from AVC, the marking in SVC is supported as follows. The marking of a base representation as “used for reference” is always the same as the corresponding decoded picture. There is therefore no additional syntax elements for marking base presentations as “used for reference.” However, marking base representations as “unused for reference” makes use of separate MMCO commands, the syntax of which is not present in AVC, to enable optimal memory usage.

The hypothetical reference decoder (HRD), specified in Annex C of H.264/AVC, is used to check bitstream and decoder conformances. The HRD contains a coded picture buffer (CPB), an instantaneous decoding process, a decoded picture buffer (DPB), and an output picture cropping block. The CPB and the instantaneous decoding process are specified similarly to any other video coding standard, and the output picture cropping block simply crops those samples from the decoded picture that are outside the signaled output picture extents. The DPB was introduced in H.264/AVC in order to control the required memory resources for decoding of conformant bitstreams. The DPB includes a unified decoded picture buffering process for reference pictures and output reordering. A decoded picture is removed from the DPB when it is no longer used as reference and not needed for output. A picture is not needed for output when either one of the two following conditions are fulfilled: the picture was already output or the picture was marked as not intended for output with the “output_flag” that is present in the NAL unit header of SVC NAL units. The maximum size of the DPB that bitstreams are allowed to use is specified in the Level definitions (Annex A) of H.264/AVC.

There are two types of conformance for decoders: output timing conformance and output order conformance. For output timing conformance, a decoder must output pictures at identical times compared to the HRD. For output order conformance, only the correct order of output picture is taken into account. The output order DPB is assumed to contain a maximum allowed number of frame buffers. A frame is removed from the DPB when it is no longer used as reference and needed for output. When the DPB becomes full, the earliest frame in output order is output until at least one frame buffer becomes unoccupied.

In multi-view video coding, video sequences output from different cameras, each corresponding to different views, are encoded into one bit-stream. After decoding, to display a certain view, the decoded pictures belonging to that view are reconstructed and displayed. It is also possible that more than one view is reconstructed and displayed.

Multi-view video coding has a wide variety of applications, including freeviewpoint video/television, 3D TV and surveillance.

A view component in MVC is referred to as a coded representation of a view in a single access unit. An anchor picture is a coded picture in which all slices may reference only slices within the same access unit, i.e., inter-view prediction may be used, but no inter prediction is used, and all following coded pictures in output order do not use inter prediction from any picture prior to the coded picture in decoding order. A base view in MVC is a view that has the minimum value of view order index in a coded video sequence. The base view can be decoded independently of other views and does not use inter-view prediction. The base view can be decoded by H.264/AVC decoders supporting only the single-view profiles, such as the Baseline Profile or the High Profile of H.264/AVC.

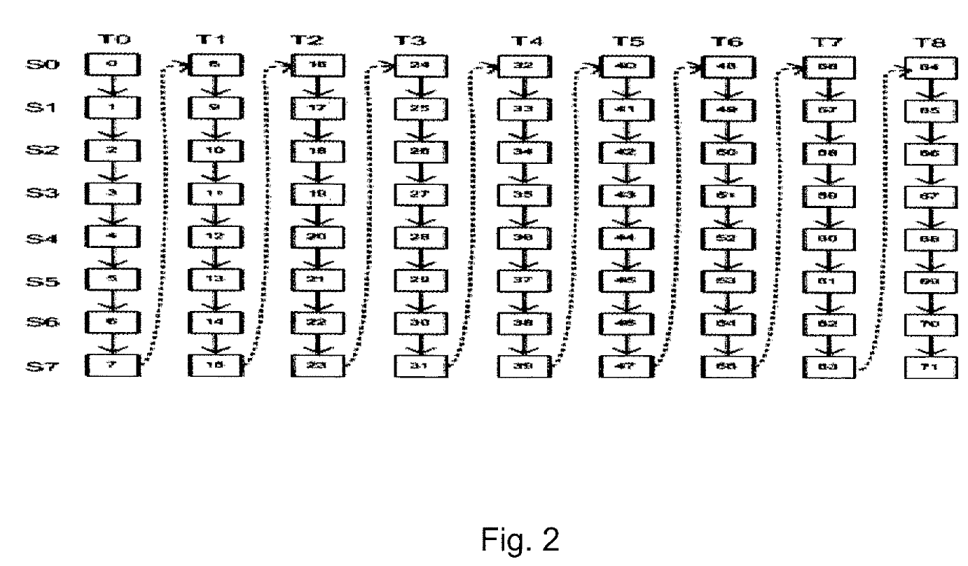

Referring now to FIG. 2, an exemplary MVC decoding order (i.e. bitstream order) is illustrated. The decoding order arrangement is referred as time-first coding. Each access unit is defined to contain the view components of all the views for one output time instance. Note that the decoding order of access units may not be identical to the output or display order.

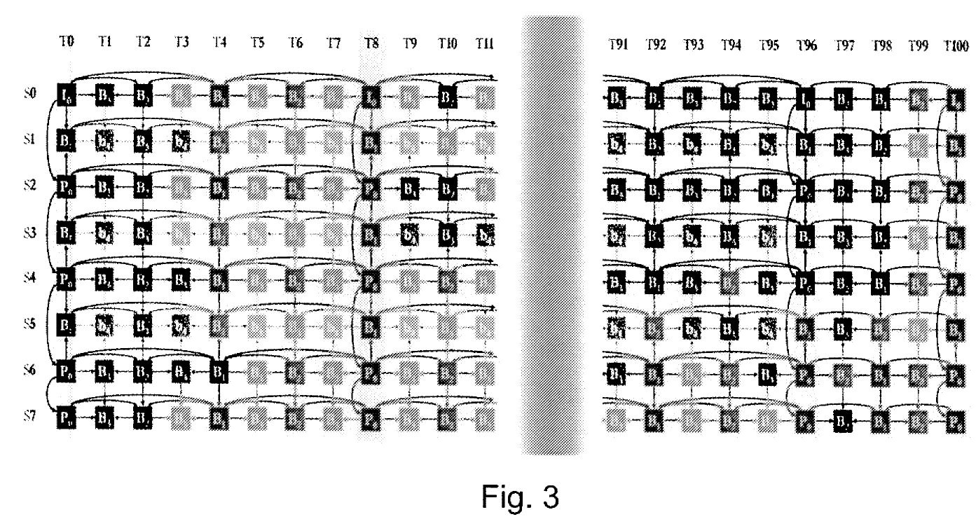

Referring now to FIG. 3, an exemplary MVC prediction (including both inter-picture prediction within each view and inter-view prediction) structure for multi-view video coding is illustrated. In the illustrated structure, predictions are indicated by arrows, the pointed-to object using the point-from object for prediction reference.

An anchor picture is a coded picture in which all slices reference only slices with the same temporal index, i.e., only slices in other views and not slices in earlier pictures of the current view. An anchor picture is signaled by setting the “anchor_pic_flag” to 1. After decoding the anchor picture, all following coded pictures in display order shall be able to be decoded without inter-prediction from any picture decoded prior to the anchor picture. If anchor_pic_flag is equal to 1 for a view component, then all view components in the same access unit also have anchor_pic_flag equal to 1. Consequently, decoding of any view can be started from a temporal index that corresponds to anchor pictures. Pictures with “anchor_pic_flag” equal to 0 are named non-anchor pictures.

In MVC, view dependencies are specified in the sequence parameter set (SPS) MVC extension. The dependencies for anchor pictures and non-anchor pictures are independently specified. Therefore anchor pictures and non-anchor pictures can have different view dependencies. However, for the set of pictures that refer to the same SPS, all the anchor pictures have the same view dependency, and all the non-anchor pictures have the same view dependency. In the SPS MVC extension, dependent views can be signaled separately for the views used as reference pictures in RefPicList0 and RefPicList1.

In MVC, there is an “inter_view_flag” in the network abstraction layer (NAL) unit header which indicates whether the current picture is not used or is allowed to be used for inter-view prediction for the pictures in other views.

In MVC, inter-view prediction is supported by texture prediction (i.e., the reconstructed sample values may be used for inter-view prediction), and only the decoded view components of the same output time instance (i.e., the same access unit) as the current view component are used for inter-view prediction. The fact that reconstructed sample values are used in inter-view prediction also implies that MVC utilizes multi-loop decoding. In other words, motion compensation and decoded view component reconstruction are performed for each view.

For the purpose of many decoding processes in MVC, a decoded picture is often used to mean a decoded view component. The process of constructing reference picture lists in MVC is summarized as follows.

First, a reference picture list is constructed including all the short-term and long-term reference pictures that are marked as “used for reference” and belong to the same view as the current slice. Those short-term and long-term reference pictures are named intra-view references for simplicity. Then, inter-view reference pictures and inter-view only reference pictures are appended after the intra-view references, according to the SPS and the “inter_view_flag,” to form an initial list. Reference picture list reordering (RPLR) is then performed when the slice header contains RPLR commands. The RPLR process may reorder the intra-view reference pictures, inter-view reference pictures and inter-view only reference pictures into a different order than the order in the initial list. Both the initial list and final list after reordering must contain only a certain number of entries indicated by a syntax element in the slice header or the picture parameter set referred by the slice.

Reference picture marking is performed identically to H.264/AVC for each view independently as if other views were not present in the bitstream.

The DPB operation is similar to that of H.264/AVC except for the following. Non-reference pictures (with “nal_ref_idc” equal to 0) that are used as for inter-view prediction reference are called inter-view only reference pictures, and the term “interview reference pictures” only refer to those pictures with “nal_ref_idc” greater than 0 and are used for inter-view prediction reference. In some draft versions of MVC, inter-view only reference pictures are marked as “used for reference”, stored in the DPB, implicitly marked as “unused for reference” after decoding the access unit, and implicitly removed from the DPB when they are no longer needed for output and inter-view reference.

In MVC, after the first byte of NAL (Network Abstraction Layer) unit, a NAL unit header extension (3 bytes) is followed. The NAL unit header extension includes the syntax elements that describe the properties of the NAL unit in the context of MVC.

Many display arrangements for multi-view video are based on rendering of a different image to viewer's left and right eyes. For example, when data glasses or auto-stereoscopic displays are used, only two views are observed at a time in typical MVC applications, such as 3D TV, although the scene can often be viewed from different positions or angles. Based on the concept of asymmetric coding, one view in a stereoscopic pair can be coded with lower fidelity, while the perceptual quality degradation can be negligible. Thus, stereoscopic video applications may be feasible with moderately increased complexity and bandwidth requirement compared to mono-view applications, even in the mobile application domain.

As backward compatibility is important in practice, a so-called asymmetric stereoscopic video (ASV) codec can encode the base view (view 0) as H.264/AVC compliant and the other view (view 1) with techniques specified in H.264/AVC as well as inter-view prediction methods. Approaches have been proposed to realize an ASV codec by invoking a downsampling process before inter-view prediction.

However, it is desirable to design the coding of low-resolution view in a manner with low computational complexity and high compression efficiency. A low complexity motion compensation (MC) scheme has been proposed to substantially reduce the complexity of asymmetric MVC without compression efficiency loss. Direct motion compensation without a downsampling process from the high resolution inter-view picture to the low resolution picture was proposed in Y. Chen, Y.-K. Wang, M. M. Hannuksela, and M. Gabbouj, “Single-loop decoding for multiview video coding,” in Proceedings of IEEE International Conference on Multimedia & Expo (ICME), June 2008, In direct motion compensation, the block of samples referred to by a motion vector pointing to an inter-view reference picture is sub-sampled to form a prediction block, i.e., only a subset of the sample values of the block in the inter-view reference picture is included in the prediction block. In another version of direct motion compensation, a filter is applied over several samples in the inter-view reference picture to obtain a sample in the prediction block. This version of direct motion compensation is described in Y. Chen, Y.-K. Wang, M. Gabbouj, and M. M. Hannuksela, “Regionally adaptive filtering for asymmetric stereoscopic video coding,” in Proceedings of IEEE International Symposium on Circuits and Systems (ISCAS), May 2009.

As noted above, compressed multi-view video sequences require a considerable bitrate. They may have been coded for a spatial resolution (picture size in terms of pixels) or picture quality (spatial details) that are unnecessary for a display in use or unfeasible for a computational or memory capacity in use while being suitable for another display and another computational complexity and memory resources in use. In many systems, it would therefore be desirable to adjust the transmitted or processed bitrate, the picture rate, the picture size, or the picture quality of a compressed multi-view video bitstream. The current multi-view video coding solutions offer scalability only in terms of view scalability (selecting which views are decoded) or temporal scalability (selecting the picture rate at which the sequence is decoded).

It is non-trivial to realize a multi-view video coding scheme where each view is coded with a scalable video codec and where inter-view prediction is enabled. It may not be possible to perform scalable adaptation of individual views cannot be done without causing a prediction drift in inter-view prediction, or multiple decoding loops within a view may be required and a lower compression efficiency may be achieved.

The following works proposed multiview video coding with spatial scalability, but inter-view prediction was used only between the decoded view components of the base layer of each view: N. Ozbek, A. M. Tekalp, and E. T. Tunali, “A New Scalable Multi-view Video Coding Configuration for Robust Selective Streaming of Free-Viewpoint TV,” Proc. of IEEE International Conference on Multimedia & Expo (ICME), pp. 1155-1158, 2007; and E. Kurutepe, M. R. Civanlar, and A. M. Tekalp, “Client-driven selective streaming of multiview video for interactive 3DTV,” IEEE Transactions on Circuits and Systems for Video Technology, vol. 17, no. 11, pp. 1558-1565, November 2007. The coding scheme presented in these works is disadvantageous when it comes to use of computational and memory resources, because when inter-view prediction is applied between the decoded pictures of the base layer, and, at the same time, inter prediction is allowed between the decoded pictures of the enhancement layer, two decoding loops are required per view. In other words, dependency representations of the base layer (having dependency_id equal to 0) for each view have to be entirely reconstructed in addition to the decoding the dependency representations with dependency_id greater than 0. Furthermore, the lack of inter-view prediction for spatial enhancement layers has a negative impact on the coding efficiency.

When spatial scalability is applied and inter-view prediction is applied from a spatial enhancement layer of a view, removal of the spatial scalable enhancement layer would cause inter-view prediction from the view containing the spatial scalable enhancement layer to fail, as the reference picture used for inter-view prediction can be of a different spatial resolution or, in case of extended spatial scalability, cover a different region of the original uncompressed picture.

In another example, when coarse granular scalability (CGS) or medium grain scalability (MGS) is applied, removal of a CGS or MGS enhancement layer would cause a prediction drift in inter-view prediction from the view containing the CGS or MGS enhancement layer, as different decoded pictures would be used as prediction in the decoder and in the encoder. The decoder would use a decoded picture resulting from the bitstream where the CGS or MGS enhancement layer is not present, whereas the encoder used a decoded picture resulting from the bitstream where the CGS or MGS enhancement layer was present.

In accordance with embodiments of the present invention, a multi-view video coding scheme is provided where at least one view is coded with a scalable video coding scheme. In one particular embodiment, a multi-view video coding extension of the Scalable Video Coding (SVC) standard is provided. In another particular embodiment a scalable video coding extension of the Multiview Video Coding (MVC) standard is provided.

Embodiments of the present invention provide a codec design that enables any view in a multi-view bitstream to be coded in a scalable fashion so that scalable layers can be pruned unevenly between views. In one embodiment, the inter-view prediction from the base view is adapted on the basis of which scalable layers are present in the non-base view. A reference picture marking design and a reference picture list construction design are provided to enable the use of any dependency representation from any other view earlier in view order than the current view for inter-view prediction.

For the dependency representation used for inter-view prediction, the reference picture marking design and reference picture list construction design in accordance with embodiments of the present invention allow for selective use of base representation or enhancement representation of the dependency representation for inter-view prediction. The enhancement representation of a dependency representation may result from decoding of a MGS layer representation or a FGS layer representation.

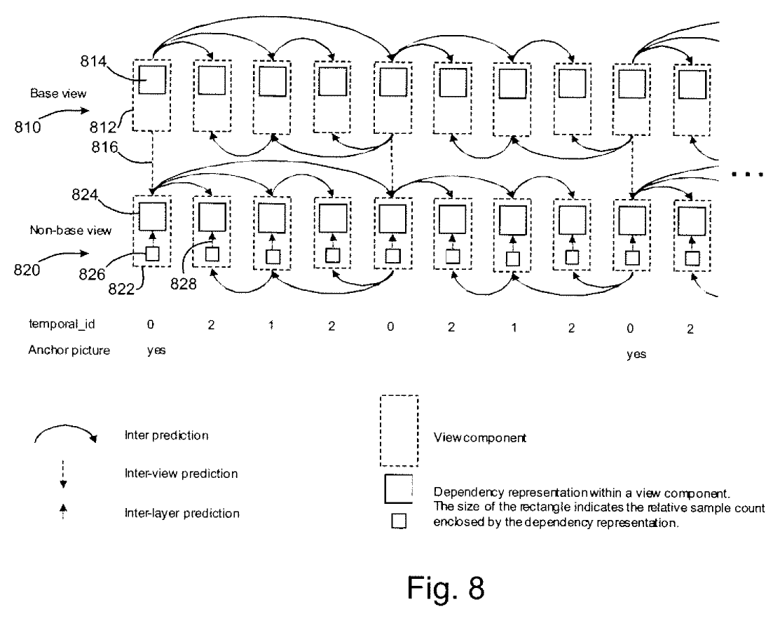

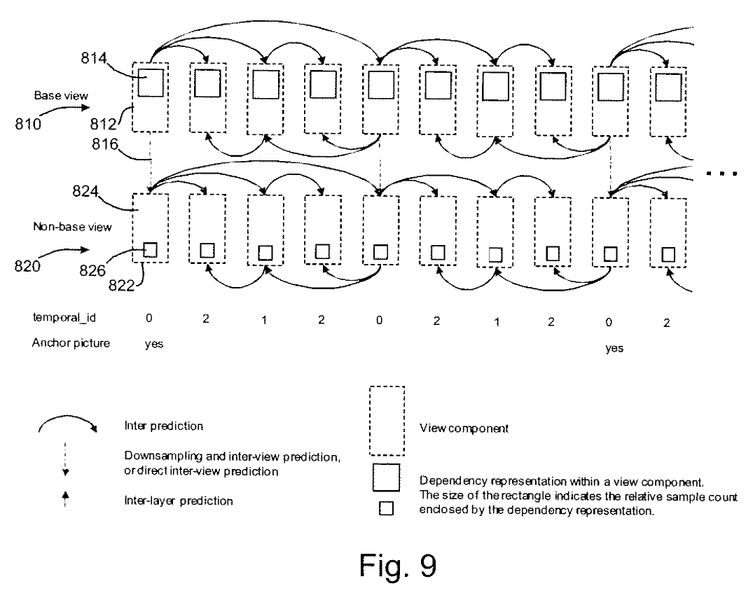

In FIG. 8 an example of a scalable stereoscopic coding scheme enabling bitstream pruning to a mixed-resolution stereoscopic video is presented. The base view 810 is coded in a non-scalable manner with H.264/AVC. The non-base view 820 is coded in a spatially scalable manner with SVC including inter-view prediction. A decoded picture of the base view can be used as inter-view prediction reference for a dependency representation of the non-base view having the same spatial resolution. This is illustrated with arrows 816 in FIG. 8. Inter-view prediction can be allowed for dependency representation having any temporal_id, not just for dependency representations having temporal_id equal to 0 as illustrated in the FIG. 8. In FIGS. 8 and 9 the size of the squares 814, 824, 826 inside the view components 812, 822 (squares with dotted lines) illustrates the relative sample count enclosed by the dependency representation. A smaller square 826 illustrates a smaller sample count than a larger square 814,

In the non-base view 820 of the example of FIG. 8 the smaller squares 826 illustrate dependency representations having dependency_id equal to 0 and the larger squares 824 illustrate dependency representations having dependency_id equal to 1. In practical situations there may also be other dependency representations having a different (a higher) dependency_id than 0 or 1.

The coded non-base view can be manipulated to achieve a mixed-resolution bitstream by excluding dependency representations having the highest dependency_id value, in this example the highest value of the dependency_id is equal to 1. In some embodiments, a mixed-resolution bitstream can be achieved by excluding more than one dependency representation per access unit, with the constraint the excluded dependency representations have higher dependency_id values than those dependency representations remaining in the same view. After removal of one or more dependency representation per access unit, inter-view prediction references may be of different spatial resolution compared to the view components of the non-base view being encoded/decoded, and hence the inter-view prediction process may be adapted. Basically, the decoded base-view pictures are downsampled prior to using them as inter-view prediction references. Alternatively, direct inter-view prediction as described in the following publications may be applied: Y. Chen, Y.-K. Wang, M. Gabbouj, and M. M. Hannuksela, “Regionally adaptive filtering for asymmetric stereoscopic video coding,” Proc. of IEEE International Symposium on Circuits and Systems (ISCAS), May 2009; Y. Chen, Y.-K. Wang, M. M. Hannuksela, and M. Gabbouj, “Picture-level adaptive filter for asymmetric stereoscopic video,” Proc. of IEEE International Conference on Image Processing (ICIP), October 2008; or Y. Chen, S. Liu, Y.-K. Wang, M. M. Hannuksela, H. Li, and M. Gabbouj, “Low-complexity asymmetric multiview video coding,” Proc. of IEEE International Conference on Multimedia & Expo (ICME), June 2008.

An example of the inter-view prediction process with downsampling or direct inter-view prediction is illustrated in FIG. 9. The dependency representations of the non-base view components 822 may be predicted using inter-view prediction from the base view 810 and inter prediction within the non-base view 820. Because the decoded view components 822 of the non-base view in FIG. 9 have a different spatial resolution than the decoded view components of the base view, the inter-view reference pictures 814 are down- or upsampled before or during the inter-view prediction. This is illustrated in FIG. 9 as dotted arrows 816 from some view components 812 of the base view to view components 822 of the non-base view within the same access unit.

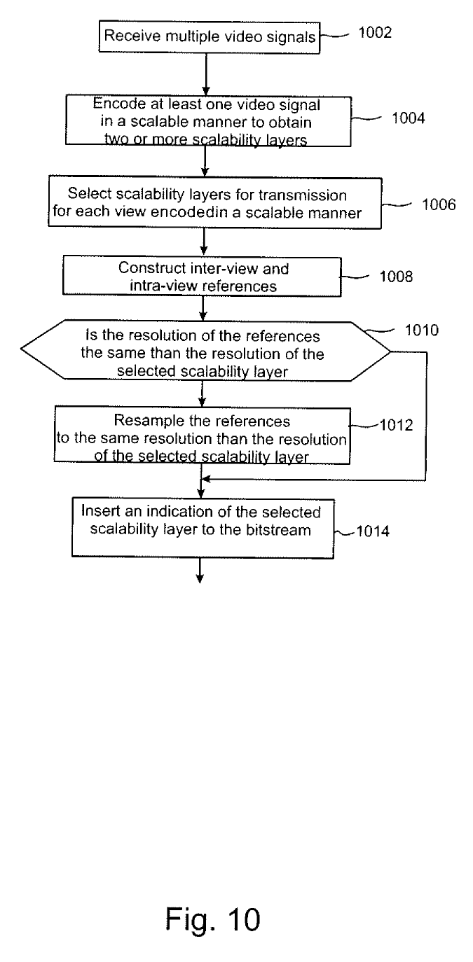

In some embodiments the encoder may operate as follows. The encoder receives 1002 (FIG. 10) two or more video signals (views) and encodes 1004 them to obtain different scalability layers. One of the video signals may represent a base view and the other video signal(s) represent non-base view(s). The base view may be encoded in a non-scalable manner and a non-base view may be encoded to obtain different scalability layers (dependency representations). The non-base view may contain dependency representations having dependency_id equal to 0 or 1. The encoder reconstructs 1008 decoded pictures having dependency_id equal to 0 and dependency_id equal to 1. For inter-view prediction of the dependency representations having a different spatial resolution 1010 than the decoded pictures of the base view, the reference pictures of the base view are resampled 1012. The resampling may be performed e.g. by filtering the reference pictures, by selecting a smaller set of samples from the reference pictures, or by using another applicable method to obtain smaller resolution pictures. Resampled reference pictures may be stored into a reference picture memory of the encoder, for example.

A resampled reference picture can be removed from the reference picture memory when it is no longer needed for inter-view reference. In some embodiments, the inter-view motion vectors may be constrained and resampling can be done in a sliding window manner, e.g. one resampled macroblock row can be added into the bottom of the sliding window when the top-most macroblock row of the sliding window is removed. In some implementations, resampling may be done in-place, i.e., only for the inter-view prediction block.

When the encoder has changed the resolution of one or more of the views, the encoder may include one or more indications 1014 into the bitstream facilitating the detection of one or more of the following.

A change in the maximum dependency_id value at the present view component requires resampling of inter-view reference pictures only, or no resampling at all, if the decoding of the view component having the new maximum dependency_id value results into the same spatial resolution as the inter-view reference pictures have. This is equivalent to IDR picture in a single-view H.264/AVC coding. When considering the example of FIG. 8, a corresponding indication, such as view_resolution_change_property equal to 0, may be associated with the non-base view component of the first anchor picture.

A change in the maximum dependency_id value at the present view component may require resampling of inter-view reference pictures. In addition, resampling of reference pictures for inter prediction of dependency representations preceding the current dependency representation in output order and following the current dependency representation in decoding order may be required. This is equivalent to open GOP intra picture in single-view coding. Bit-exact decoding of so-called leading pictures (/dependency representations) might not be possible. When considering the example of FIG. 8, a corresponding indication, such as view_resolution_change_property equal to 1, may be associated with the non-base view component of the second anchor picture.

A change in the maximum dependency_id value at the present view component may require resampling of inter and inter-view reference pictures. Bit-exact decoding of dependency representations preceding the next dependency representation causing a decoding refresh might not be possible. When considering the example of FIG. 8, a corresponding indication, such as view_resolution_change_property equal to 2, may be associated with the non-base view component of the second access unit having temporal_id equal to 0.

The above-mentioned one or more indications may be included in one or more various syntax structures, such as NAL unit header, prefix NAL unit, payload content scalability information (PACSI) NAL unit, supplemental enhancement information message, a slice header, a picture header, a picture parameter set, and a sequence parameter set (where the indications may be associated to view components having certain temporal_id values). In addition or alternatively, the above-mentioned one or more indications may be included in metadata in a file encapsulating the video bitstream or in a header field of a packet encapsulating at least a part of the video bitstream, such as a Real-time Transport Protocol (RTP) payload header or a RTP packet header.

In a bitstream conversion operation, some of the view components are modified by pruning dependency representations. The conversion may happen in the sender 130, the gateway 140, the receiver 150, or the decoder 160. The sender 130 may send the bitstream to the gateway 140 which may forward the bitstream to the receiver 150 which may provide the bitstream to the decoder for decoding and possibly for presenting the decoded presentation to a viewer. If the sender 130 decides to convert the bitstream, the sender 130 prunes one or more dependency representations from the bitstream before sending it to the gateway 140 and may provide in the bitstream an indication of the pruning. Correspondingly, if the gateway 140 decides to convert the bitstream, the gateway 140 prunes one or more dependency representations from the bitstream before sending it to the receiver 150 and may provide in the bitstream an indication of the pruning. If the receiver 150 decides to convert the bitstream, the receiver 150 prunes one or more dependency representations from the bitstream before providing the bitstream to the decoder 160 and may also provide to the decoder 150 an indication of the pruning.

The decision to convert may happen on the basis of e.g. one or more of the following situations. A downlink throughput is estimated or reported e.g. by the gateway 140 or by the sender 130 to be lower than the bitrate of the bitstream. Hence, bitrate adaptation of the bitstream is needed to reduce the bitrate of the bitstream. The computational or memory capacity of the decoder may not be sufficient for the decoding of the entire bitstream. Hence, the decoder 160 may inform the receiver 150 to adapt the bitrate. It may also happen that the viewer of the video representation is detected or estimated to be so far from the display that the perceptual quality of mixed-resolution stereoscopic video is approximately equal to that of full-resolution stereoscopic video wherein bitrate may be adapted to a lower level. Also if there are more data streams transmitted through the network and/or processed by the decoding device, and the perceptual quality decrease caused by mixed-resolution stereoscopic or multiview video is estimated to be less annoying than bitrate and/or complexity adaptation of the other data streams, the resolution of one or more views of the stereoscopic or multiview video may be decreased.

The converter 180, which may be located in or attached with the sender 130, the gateway 140, the receiver 150, and/or the decoder 160, may read one or more indications from the bitstream or from packets headers or alike associated with the bitstream facilitating the detection of which decoded reference pictures may have to be resampled and whether a drift in sample values of the decoded pictures may be possible. The converter may decide the access unit or view component on which a change in the maximum dependency_id value is made based on its knowledge how the decoder supports reference picture resampling (resampling for inter-view reference pictures only or resampling of inter-view and inter reference pictures). Alternatively or in addition, the converter may decide the access unit or view component on which a change in the maximum dependency_id value is made based on the existence and potential duration of drift in sample values (no drift, drift only in leading pictures, drift until the next refresh dependency representation).

The converter may prune NAL units of the selected view on the basis of their dependency_id value in accordance with the sub-bitstream extraction process of clause G.8.8.1 of H.264/AVC.

The decoder may detect if an inter-view reference picture has a different spatial resolution than the non-base view component being decoded. That being the case, the decoder resamples the inter-view reference picture to the same spatial resolution as the non-base view component being decoded. Then, the decoder decodes the non-base view component using the resampled inter-view reference picture for inter-view prediction. As mentioned above, the resampling may also be done in a sliding window manner, e.g. one resampled macroblock row at a time, or in-place, i.e., only for one inter-view prediction block at a time.

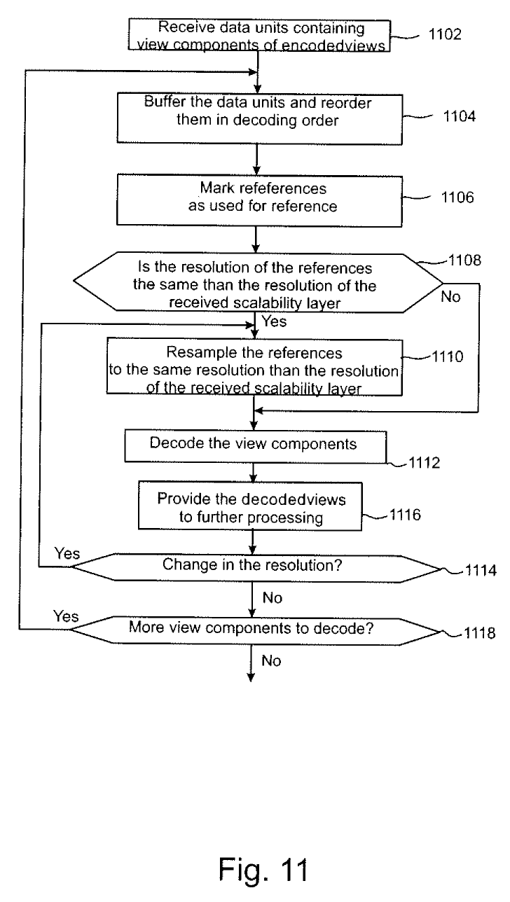

In some embodiments the decoder may operate as follows. The decoder receives 1102 (FIG. 11) an encoded bitstream containing view components of two or more video signals and decodes the bit stream to reconstruct the original view components. The bitstream may contain data units (e.g. NAL units) in which the encoded view components have been transmitted. The decoder (or the receiver 150) buffers the view components and rearranges them into a decoding order if the decoding order is different from the transmission order (block 1104). The decoder may also examine e.g. by using a reference picture list to determine whether the view components is used as a reference. If so, the decoder may mark 1106 the reference view components as “used for reference”. The decoder may also examine 1108 whether the resolution of the inter-view reference view components differ from the resolution of the view components to be predicted on the basis of the inter-view reference view components. The inter-view reference view components are resampled 1110 to the resolution corresponding with the resolution of the view components to be predicted.

The decoder decodes 1112 the view components using reference view components in the decoding when the view components are predicted view components.

If the spatial resolution of one or more views changes 1116, the corresponding inter-view reference view components may be resampled, if necessary.

The decoded view components can be provided 1114 to a renderer for displaying, to a memory for storing, etc.

The above processed may be repeated 1116 until the whole bitstream has been received and decoded.

In one embodiment, the resolutions of the base view and the resolution of the base layer of the non-base view are the same. The non-base view has an enhancement layer increasing the resolution compared to that of the base layer. For the encoding/decoding of the enhancement layer, the inter-view reference pictures are (implicitly) upsampled. Such embodiment can be used to provide a possibility for mixed-resolution improvement to a symmetric bitstream, such as a standard-compliant MVC bitstream.

In one embodiment, more than two views are coded where one or more views is coded in spatially scalable manner. Resampling of inter-view reference pictures is applied whenever a view is coded/decoded at a different resolution than its reference view. A pruning order indicator may be used to indicate the intended order of pruning spatial layers from the multiview bitstream. An encoder or a bitstream analyzer may create the values of the pruning order indicator based on the reference pictures it has used for inter-view prediction. Encoders may select inter, inter-layer and inter-view prediction references such a way that any bitstream extraction performed according to the pruning order indicator results into a valid bitstream. A pruning order indication may be included in the bitstream, metadata included in a file encapsulating the bitstream, or a packet header or alike encapsulating at least a part of the bitstream. The pruning order indicator can be realized with a “priority_id” syntax element included in each NAL unit header. A bitstream subset containing all the NAL units having pruning order values less than or equal to any chosen value is a valid bitstream. For example, a bitstream may contain three views, where view 2 depends on view 1 and view 1 depends on view 0 (the base view) and at least views 1 and 2 are have spatial scalability layers with equal resolution across the views. Then, pruning order indicator may indicate that the spatial enhancement layer of view 2 is to be pruned before the spatial enhancement layer of view 1. Consequently, the base layer of view 2 is inter-view predicted from the downsampled decoded view components of view 1 (decoded using both its base and enhancement layers).

In some embodiments the base view may also be scalably coded and the spatial resolution of the base view may be changed. It may also be possible that the non-base view is coded in a non-scalable manner and the base view is coded in a spatially scalable manner.

If spatially scalable view components of a reference view are used as inter-view prediction references for view components of a second view, it may become ambiguous whether a resampled decoded view component resulting from decoding the highest dependency representation or the decoded view component resulting from decoding the dependency representation having the same spatial resolution as the view component in the second view should be decoded. If the encoder has used the resampled decoded view component resulting from decoding the highest dependency representation but the highest dependency representation has been subsequently removed by a converter or alike, the decoder typically uses the decoded view component resulting from decoding the dependency representation having the same spatial resolution as the view component in the second view as the inter-view prediction reference. If the encoder has used the decoded view component resulting from decoding the dependency representation having the same spatial resolution as the view component in the second view and no dependency representation from the reference view has been subsequently removed by a converter or alike, the decoder should reconstruct both the resampled decoded view component resulting from decoding the highest dependency representation and the decoded view component resulting from decoding the dependency representation having the same spatial resolution as the view component in the second view. Hence, multiple decoded pictures per view per access unit are required to be decoded.

In order to control the decoding of the required inter-view prediction reference pictures when spatially scalable view components of a reference view are used as inter-view prediction references for view components of a second view, the encoder may operate as follows. The encoder may set one or more indications, such as a inter_view_ubp_flag equal to 1, for those access units or view components when it uses the lowest dependency representation for inter-view reference of a view component in a second view. Two decoded view components for the reference view component are typically reconstructed by the encoder and the decoder when inter_view_ubp_flag is equal to 1, one (so-called inter-view reference picture) from the dependency representation with dependency_id equal to 0 and another one from all dependency representations that are present. As the lowest dependency representation is always present regardless of potential pruning operations, the potential mismatch between the encoder and decoder reconstructions is stopped when inter_view_ubp_flag is equal to 1. The encoder may therefore adaptively select the interval of view component in the reference view for which inter_view_ubp_flag is equal to 1. The higher the frequency of view components with inter_view_ubp_flag equal to 1 is, the shorter in duration the potential mismatch periods are but also the higher the computational complexity for decoding is. In some embodiments, leaky inter-view prediction is used, where multi-hypothesis prediction, such as bi-prediction, is used and the weight of the prediction blocks from the inter-view reference base pictures is adaptively selected.

An exemplary codec in accordance with embodiments of the present invention is described below. All the processes that are specified in SVC and MVC apply as such or are modified in the description of the exemplary codec below.

### NAL Unit Header

The NAL unit syntax (i.e., nal_unit( )), is as specified in MVC. The syntax and semantics of the proposed NAL unit header are as follows. The first byte of the NAL unit header consists of forbidden_zero_bit (1 bit), nal_ref_idc (2 bits), and nal_unit_type (5 bits), same as in H.264/AVC, SVC, and MVC. The rest of the bytes of the NAL unit header are contained in the syntax structure nal_unit_header_svc_mvc_extension( ) defined as follows:

| nal_unit_header_svc_mvc_extension( ) { | C | Descriptor |
|---|---|---|
| svc_mvc_extension_flag | All | u(1) |
| idr_flag | All | u(1) |
| priority_id | All | u(6) |
| no_inter_layer_pred_flag | All | u(1) |
| dependency_id | All | u(3) |
| quality_id | All | u(4) |
| temporal_id | All | u(3) |
| use_ref_base_pic_flag | All | u(1) |
| discardable_flag | All | u(1) |
| output_flag | All | u(1) |
| reserved_three_2bits | All | u(2) |
| anchor_pic_flag | All | u(1) |
| view_id | All | u(10) |
| inter_view_flag | All | u(1) |
| inter_view_ubp_flag | All | u(1) |
| reserved_seven_3bits | All | u(3) |
| } | | |

The semantics of forbidden_zero_bit, nal_ref_idc and nal_unit_type are as specified in SVC, with the following additions.

NAL units with “nal_unit_type” equal to 1 to 5 is only used for the base view as specified in MVC. Within the base view, the use of NAL units with “nal_unit_type” equal to 1 to 5 is as specified in SVC. Prefix NAL units shall only appear in the base layer in the base view. The base layer in the base view is as specified in SVC. For non-base views, coded slice NAL units with “dependency_id” equal to 0 and “quality_id” equal to 0 have “nal_unit_type” equal to 20, and prefix NAL units are not be present.

When the current NAL unit is a prefix NAL unit with “nal_unit_type” equal to a value reserved for the scalable multiview coding slices, all the syntax elements in “nal_unit_header_svc_mvc_extension( )” also apply to the NAL unit that directly succeeds the prefix NAL unit in decoding order. An NAL unit that directly succeeds a prefix NAL unit is considered to contain these syntax elements with values identical to that of the prefix NAL unit.

“svc_mvc_extension_flag” is reserved for future extensions and is set to 0.

“idr_flag” equal to 1 specifies that the current access unit is an IDR access unit when all the view components in the current access unit are IDR view components. A view component consists of all the NAL units in one access unit having identical “view_id.” An IDR view component refers to a view component for which the dependency representation with the greatest value of “dependency_id” among all the dependency representations within the view component has “idr_flag” equal to 1 or “nal_unit_type” equal to 5.

The semantics of “priority_id” are as specified in MVC.

The semantics of “no_inter_layer_pred_flag” are as specified in SVC.

“dependency_id” specifies a dependency identifier for the NAL unit. “dependency_id” is equal to 0 in VCL prefix NAL units. NAL units having the same value of “dependency_id” within one view comprise a dependency representation. Within a bitstream, a dependency representation is identified by a pair of “view_id” and “dependency_id” values.

The semantics of “quality_id” is as specified in SVC, with the following applies in addition. NAL units having the same value of “quality_id” within one dependency representation comprise a layer representation. Within a bitstream, a layer representation is identified by a set of “view_id,” “dependency_id” and “quality_id” values.

The semantics of temporal_id are as specified in MVC.

“use_ref_base_pic_flag” equal to 1 specifies that reference base pictures (also referenced to as base representations) are used as reference pictures for the inter prediction process. “use_ref_base_pic_flag” equal to 0 specifies that decoded pictures (also referred to as enhancement representations) are used as reference pictures during the inter prediction process. The values of “use_ref_base_pic_flag” is the same for all NAL units of a dependency representation. “use_ref_base_pic_flag” is equal to 0 in filler prefix NAL units.

“discardable_flag” equal to 1 specifies that the current NAL unit is not used for decoding NAL units of the current view component and all subsequent view components of the same view that have a greater value of “dependency_id” than the current NAL unit. “discardable_flag” equal to 0 specifies that the current NAL unit may be used for decoding NAL units of the current view component and all subsequent view components of the same view that have a greater value of “dependency_id” than the current NAL unit. “discardable_flag” is equal to 1 in filler prefix NAL units.

The semantics of “output_flag” and “reserved_three_{—}2 bits” are as specified in SVC.

“anchor_picture_flag” equal to 1 specifies that the current view component is an anchor picture as specified in MVC when the value of “dependency_id” for the NAL unit is equal to the maximum value of “dependency_id” for the view component. “anchor_picture_flag” is identical for all NAL units within a dependency representation.

The semantics of “view_id” are as specified in MVC.

“inter_view_flag” equal to 0 specifies that the current dependency representation is not used for inter-view prediction. “inter_view_flag” equal to 1 specifies that the current dependency representation is used for inter-view prediction.

“inter_view_ubp_flag” equal to 1 specifies that the current dependency representation uses base representations for inter-view prediction. A base representation for inter-view prediction is decoded from a view component with dependency_id equal to 0 and quality_id equal to 0 in the reference view in the same access unit as the current dependency representation. If the base representation for inter-view prediction is of different spatial resolution from the spatial resolution of the current dependency representation, the base representation for inter-view prediction is re-sampled to the same resolution current dependency representation. “inter_view_ubp_flag” equal to 0 specifies that the current dependency representation does not use base representations for inter-view prediction.

The values of “inter_view_ubp_flag” are the same for all NAL units of a dependency representation.

“reserved_seven_{—}3 bits” shall be equal to 7. Decoders shall ignore the value of “reserved_seven_{—}3 bits.”

### Prefix NAL Unit

The prefix NAL unit RBSP syntax, “prefix_nal_unit_rbsp( )” and the semantics of the fields therein are as specified in SVC.

### Reference Picture Marking

Reference picture marking as specified in SVC applies independently for each view. Note that inter-view only reference pictures (with “nal_ref_idc” equal to 0 and “inter_view_flag” equal to 1) are not marked by the reference picture marking process.

### Reference Picture List Construction

In one embodiment, the reference picture lists construction process is described as follows. A variable biPred is derived as follows:

If the current slice currSlice is a B or EB slice, biPred is set equal to 1;

Otherwise, biPred is set equal to 0.

A reference picture list initialization process is invoked as specified in subclause G.8.2.3 of SVC (excluding the reordering process for reference picture lists). After that, an appending process for inter-view reference pictures and interview only reference pictures as specified in subclause H.8.2.1 of MVC is invoked with the following modification. During the invocation of the appending process, if the current slice has “inter_view_ubp_flag” equal to 1, then only base representations for inter-view prediction are considered; Otherwise the decoded pictures (i.e. enhancement representations) are considered for inter-view prediction.

The initial reference picture lists RefPicList0 and, when biPred is equal to 1, RefPicList1 are modified by invoking the reordering process for reference picture lists as specified in subclause H.8.2.2.2 of MVC. During the reordering process in subclause H.8.2.2.2, if a view component which is not belonging to the current view is targeted for reordering, when “inter_view_ubp_flag” is equal to 1 for the current slice, the decoded base picture for inter-view prediction of that view component is used, otherwise, the decoded picture (i.e. the enhancement representation) of that view component is used.

In accordance with a second embodiment, the reference picture lists construction process is described as follows. Note that this embodiment can use the base representation of one inter-view reference picture or inter-view only reference picture and the enhancement representation of another inter-view reference picture or inter-view only reference picture for coding of one slice. Extra syntax elements are added in the reference picture list reordering syntax table.

“use_inter_view_base_flag” equal to 0 indicates that for the current view component being reordered, its base representation is to be added into the reference picture list. The value equal to 1 indicates that its enhancement representation is to be added into the reference picture list. The values of “use_inter_view_base_flag” may be such that all occurrences of the same inter-view reference picture or inter-view only reference picture in the final reference picture list are either all base representations or all enhancement representations.

The reference picture list construction processes are specified as follows. A reference picture list

| ref_pic_list_reordering( ){ | C | Descriptor |
|---|---|---|
| if(slice_type!=I&&slice_type!=){ | | |
| ref_pic_list_reordering_flag_l0 | 2 | u(1) |
| if(ref_pic_list_reordering_flag_l0) | | |
| do{ | | |
| reordering_of_pic_nums_idc | 2 | ue(v) |
| if(reordering_of_pic_nums_idc==0\|\| | | |
| reordering_of_pic_nums_idc==1) | | |
| abs_diff_pic_num_minus1 | 2 | ue(v) |
| elseif(reordering_of_pic_nums_idc==2) | | |
| long_term_pic_num | 2 | ue(v) |
| elseif(reordering_of_pic_nums_idc==4\|\| | | |
| reordering_of_pic_nums_idc==5) | | |
| abs_diff_view_idx_minus1 | 2 | ue(v) |
| use_inter_view_base_flag | 2 | u(1) |
| }while(reordering_of_pic_nums_idc!=3) | | |
| } | | |
| if(slice_type==B\|\|slice_type==EB) { | | |
| ref_pic_list_reordering_flag_l1 | 2 | u(1) |
| if(ref_pic_list_reordering_flag_l1) | | |
| do { | | |
| reordering_of_pic_nums_idc | 2 | ue(v) |
| if(reordering_of_pic_nums_idc==0\|\| | | |
| reordering_of_pic_nums_idc==1) | | |
| abs_diff_pic_num_minus1 | 2 | ue(v) |
| elseif(reordering_of_pic_nums_idc==2) | | |
| long_term_pic_num | 2 | ue(v) |
| elseif(reordering_of_pic_nums_idc==4\|\| | | |
| reordering_of _pic_nums_idc==5) | | |
| abs_diff_view_idx_minus1 | 2 | ue(v) |
| use_inter_view_base_flag | 2 | u(1) |
| } while(reordering_of_pic_nums_idc!=3) | | |
| } | | |
| } | | |

process is invoked as specified in subclause G.8.2.3 of SVC (excluding the reordering process for reference picture lists). After that, an appending process for inter-view reference pictures and inter-view only reference pictures as specified in subclause H.8.2.1 of MVC is invoked with the following modification. During the invocation of the appending process, only the decoded pictures (i.e. enhancement representations) are considered.

The initial reference picture lists RefPicList0 and RefPicList1 (when biPred is equal to 1) are modified by invoking the reordering process for reference picture lists as specified in subclause H.8.2.2.2 for MVC. During the reordering process in subclause H.8.2.2.2, if a view component which is not belonging to the current view is targeted for reordering, when “use_inter_view_base_flag” is equal to 1, the base representation of that view component is used, otherwise (when the flag is equal to 0), the enhancement representation of that view component is used.

### Decoding Process

For any view component, the dependency representation with the highest value for “dependency_id” is decoded. If inter_view_ubp_flag is equal to 1, the base representation for inter-view prediction is additionally reconstructed for view components used as inter-view reference. If a decoded view component or a base representation for inter-view prediction is used for inter-view prediction and has a different spatial resolution than the view component being decoded, the decoded view component or the base representation for inter-view prediction (whichever is referred to in inter-view prediction) is re-sampled to the same spatial resolution as the view component being decoded. If re-sampling is a down-sampling operation, for example a filter with taps {2, 0, −4, −3, 5, 19, 26, 19, 5, −3, −4, 0, 2}/64 may be used. If re-sampling is an up-sampling operation, the SVC up-sampling filter may be used. As mentioned above, the resampling may also be done in a sliding window manner, e.g. one resampled macroblock row at a time, or in-place, i.e., only for one inter-view prediction block at a time. Direct motion compensation or sub-sampling may also be used for re-sampling. Otherwise, the SVC decoding process is used with the modifications specified above.

### Leaky Inter-View Prediction

One aspect of the invention allows so-called leaky inter-view prediction. In other words, a prediction block can be formed by a weighted average of a base representation and an enhancement representation of an inter-view reference picture or inter-view only reference picture. This feature can be used to control the potential drift propagation caused by inter-view prediction from quality-scalable (either MGS or FGS) views.

One way to realize leaky inter-view prediction is implemented in a similar way as described above but both base representation and enhancement representation for one inter-view reference picture or inter-view only reference picture are allowed in a reference picture list. Weighted bi-prediction is used to control the averaging between a base representation and an enhancement representation. In this case, only the semantics of the “use_inter_view_base_flag” is to be changed such that the constraint in the semantics does not apply. That is, the values of “use_inter_view_base_flag” need not be such that all occurrences of the same interview reference picture or inter-view only reference picture in the final reference picture list are either base representations or enhancement representations. In other words, a final reference picture list can include both a base representation and an enhancement representation of the same inter-view reference picture or inter-view only reference picture.

### Asymmetric Scalable Multi-View Coding

In accordance with embodiments of the invention, an encoder, a decoder and a bitstream for scalable asymmetric multi-view video coding may be provided. When the spatial resolution of a decoded picture used as inter-view reference differs from that of the current picture, resampling of the inter-view reference picture or inter-view only reference picture is inferred and performed.

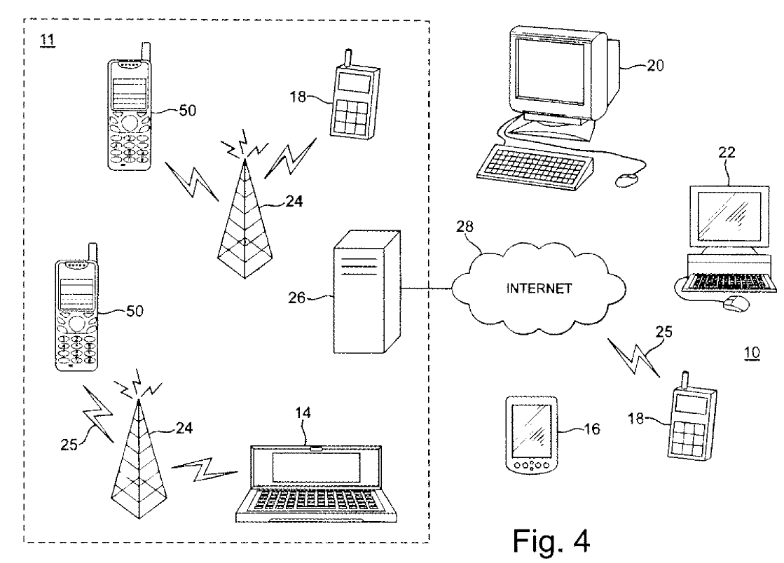

FIG. 4 shows a system 10 in which various embodiments of the present invention can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 4 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, an electronic device 12 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

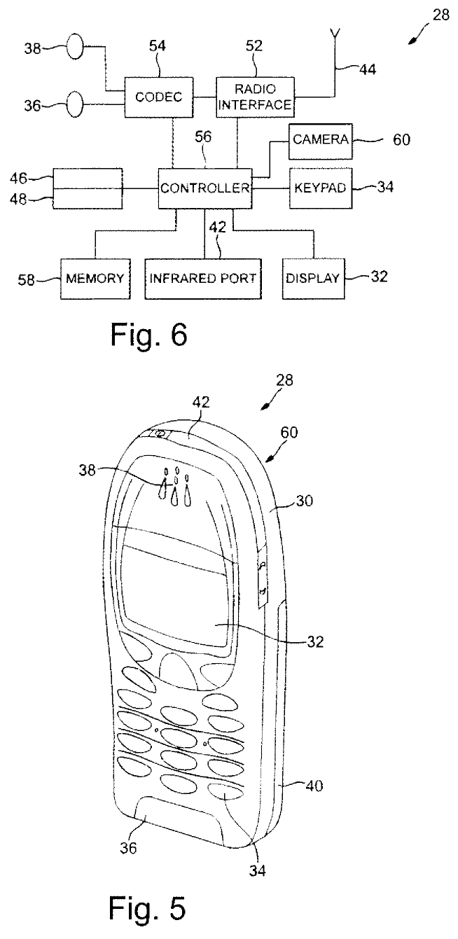

FIGS. 5 and 6 show one representative electronic device 28 which may be used as a network node in accordance to the various embodiments of the present invention. It should be understood, however, that the scope of the present invention is not intended to be limited to one particular type of device. The electronic device 28 of FIGS. 5 and 6 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. The electronic device 28 may also include a camera 60. The above described components enable the electronic device 28 to send/receive various messages to/from other devices that may reside on a network in accordance with the various embodiments of the present invention. Individual circuits and elements are all of a type well known in the art, for example in the Nokia range of mobile telephones.

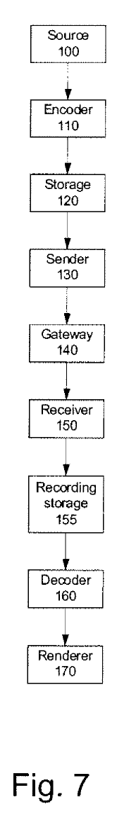

FIG. 7 is a graphical representation of a generic multimedia communication system within which various embodiments may be implemented. As shown in FIG. 7, a data source 100 provides a source signal in an analog, uncompressed digital, or compressed digital format, or any combination of these formats. An encoder 110 encodes the source signal into a coded media bitstream. It should be noted that a bitstream to be decoded can be received directly or indirectly from a remote device located within virtually any type of network. Additionally, the bitstream can be received from local hardware or software. The encoder 110 may be capable of encoding more than one media type, such as audio and video, or more than one encoder 110 may be required to code different media types of the source signal. The encoder 110 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in FIG. 7 only one encoder 110 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream is transferred to a storage 120. The storage 120 may comprise any type of mass memory to store the coded media bitstream. The format of the coded media bitstream in the storage 120 may be an elementary self-contained bitstream format, or one or more coded media bitstreams may be encapsulated into a container file. If one or more media bitstreams are encapsulated in a container file, a file generator (not shown in the figure) may used to store the one more media bitstreams in the file and create file format metadata, which is also stored in the file. The encoder 110 or the storage 120 may comprise the file generator, or the file generator is operationally attached to either the encoder 110 or the storage Some systems operate “live”, i.e. omit storage and transfer coded media bitstream from the encoder 110 directly to the sender 130. The coded media bitstream is then transferred to the sender 130, also referred to as the server, on a need basis. The format used in the transmission may be an elementary self-contained bitstream format, a packet stream format, or one or more coded media bitstreams may be encapsulated into a container file. The encoder 110, the storage 120, and the server 130 may reside in the same physical device or they may be included in separate devices. The encoder 110 and server 130 may operate with live real-time content, in which case the coded media bitstream is typically not stored permanently, but rather buffered for small periods of time in the content encoder 110 and/or in the server 130 to smooth out variations in processing delay, transfer delay, and coded media bitrate.

The server 130 sends the coded media bitstream using a communication protocol stack. The stack may include but is not limited to Real-Time Transport Protocol (RTP), User Datagram Protocol (UDP), and Internet Protocol (IP). When the communication protocol stack is packet-oriented, the server 130 encapsulates the coded media bitstream into packets. For example, when RTP is used, the server 130 encapsulates the coded media bitstream into RTP packets according to an RTP payload format. Typically, each media type has a dedicated RTP payload format. It should be again noted that a system may contain more than one server 130, but for the sake of simplicity, the following description only considers one server 130.

If the media content is encapsulated in a container file for the storage 120 or for inputting the data to the sender 130, the sender 130 may comprise or be operationally attached to a “sending file parser” (not shown in the figure). In particular, if the container file is not transmitted as such but at least one of the contained coded media bitstream is encapsulated for transport over a communication protocol, a sending file parser locates appropriate parts of the coded media bitstream to be conveyed over the communication protocol. The sending file parser may also help in creating the correct format for the communication protocol, such as packet headers and payloads. The multimedia container file may contain encapsulation instructions, such as hint tracks in the ISO Base Media File Format, for encapsulation of the at least one of the contained media bitstream on the communication protocol.

The server 130 may or may not be connected to a gateway 140 through a communication network. The gateway 140 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. Examples of gateways 140 include MCUs, gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 140 may be called an RTP mixer or an RTP translator and may act as an endpoint of an RTP connection.

The system includes one or more receivers 150, typically capable of receiving, de-modulating, and de-capsulating the transmitted signal into a coded media bitstream. The coded media bitstream is transferred to a recording storage 155. The recording storage 155 may comprise any type of mass memory to store the coded media bitstream. The recording storage 155 may alternatively or additively comprise computation memory, such as random access memory. The format of the coded media bitstream in the recording storage 155 may be an elementary self-contained bitstream format, or one or more coded media bitstreams may be encapsulated into a container file. If there are multiple coded media bitstreams, such as an audio stream and a video stream, associated with each other, a container file is typically used and the receiver 150 comprises or is attached to a container file generator producing a container file from input streams. Some systems operate “live,” i.e. omit the recording storage 155 and transfer coded media bitstream from the receiver 150 directly to the decoder 160. In some systems, only the most recent part of the recorded stream, e.g., the most recent 10-minute excerption of the recorded stream, is maintained in the recording storage 155, while any earlier recorded data is discarded from the recording storage 155.

The coded media bitstream is transferred from the recording storage 155 to the decoder 160. If there are many coded media bitstreams, such as an audio stream and a video stream, associated with each other and encapsulated into a container file or a single media bitstream is encapsulated in a container file e.g. for easier access, a file parser (not shown in the figure) is used to decapsulate each coded media bitstream from the container file. The recording storage 155 or a decoder 160 may comprise the file parser, or the file parser is attached to either recording storage 155 or the decoder 160.

The coded media bitstream may be processed further by a decoder 160, whose output is one or more uncompressed media streams. Finally, a renderer 170 may reproduce the uncompressed media streams with a loudspeaker or a display, for example. The receiver 150, recording storage 155, decoder 160, and renderer 170 may reside in the same physical device or they may be included in separate devices.

A sender 130 according to various embodiments may be configured to select the transmitted layers for multiple reasons, such as to respond to requests of the receiver 150 or prevailing conditions of the network over which the bitstream is conveyed. A request from the receiver can be, e.g., a request for a change of layers for display or a change of a rendering device having different capabilities compared to the previous one.

The receiver 150 may comprise a proximity detector or may be able to receive signals from a separate proximity detector to determine the distance of the viewer from the display and/or the position of the head of the viewer. On the basis of this distance determination the receiver 150 may instruct the decoder 160 to change the spatial resolution of one or more of the views to be displayed. In some embodiments, the receiver 150 may communicate with the encoder 130 to inform the encoder 130 that the spatial resolution of one or more of the view can be adapted.

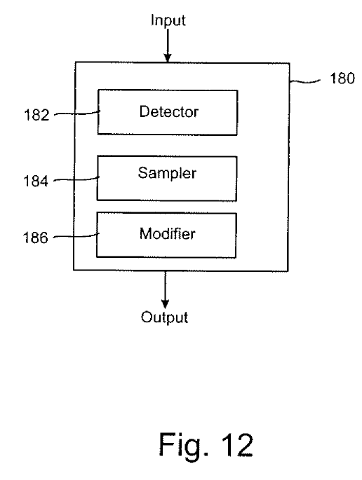

FIG. 12 is a schematic representation of a converter 180 according to an example embodiment of the present invention. The converter 180 may comprise a detector 182 to detect which decoded reference pictures may have to be resampled and whether a drift in sample values of the decoded pictures may be possible, a sampler 184 to resample reference pictures, and a modifier 186 to prune or otherwise modify data units of the view(s).

In one example embodiment the proximity detector is implemented by using a camera of the receiving device and analyzing the image signal from the camera to determine the distance and/or the head position of the viewer.

In the following table some characteristics of some video applications are listed in terms of the availability of a back-channel connection from the recipient to the sender to control the encoding and/or video adaptation for transmission communication network; and encoding of the video content (live and/or pre-recorded).

TABLE 1
Characteristics of video applications.

| | Availability of | |
|---|---|---|
| | back-channel | |
| | from recipient | |
| | to sender | Encoding |
| Video telephone, single | Yes | Live, tailored to recipient |
| recipient | | |
| Video conferencing, | Yes (might be | Live, typically not tailored |
| multiple recipients | limited if the | to recipient |
| | number of | |
| | recipients is | |
| | large) | |
| Unicast streaming | Yes | Live (typically not tailored |
| | | to recipient) or pre-recorded |
| Broadcast/multicast | No or very | Live (not tailored to |
| streaming | limited | recipient) or pre-recorded |
| File playback | No | Pre-recorded |

When compared to symmetric spatial scalability of multiview video coding, the invention provides a possibility for mixed-resolution stereoscopic video, which may provide a subjective quality close to that of full-resolution stereoscopic video particularly when the viewer is relatively far from the display. Some embodiments of the invention also provide finer granularity in bitrate adaptation, as only one view is required to be adapted at a time.

When compared to non-scalable multiview video coding, some embodiments of the invention facilitate adaptation of bitrate and view resolution at a stage subsequent to encoding. If non-scalable multiview video coding is used to provide similar adaptation functionality to the invention, either of the following options may be used:

Simulcast coding. The base view is encoded at full resolution as an independent bitstream. Two independent bitstreams are coded for the non-base view, one at lower resolution and another at full resolution.

Inter-view predicted coding with both full- and low-resolution non-base view (referred to as IVP coding). The base view is encoded at full resolution. Two versions of the non-base view are coded into the same bitstream also containing the coded base view. One of the coded non-base views is of lower resolution, and the other one is of full resolution. Both views are coded non-scalably. For the coding and decoding of the lower resolution non-base view, reference pictures of the full-resolution base view are resampled and included in the reference picture list of the respective non-base view component.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

According to a first embodiment there is provided a method for encoding a first uncompressed picture of a first view and a second uncompressed picture of a second view into a bitstream comprising:

encoding the first uncompressed picture;

reconstructing a first decoded picture on the basis of the encoding of the first uncompressed picture;

resampling at least a part of the first decoded picture into a first resampled decoded picture; and

encoding the second uncompressed picture as a first dependency representation and a second dependency representation,

wherein the first resampled decoded picture is used as a prediction reference for the encoding of the first dependency representation;

the first decoded picture is used as a prediction reference for the encoding of the second dependency representation; and

the first dependency representation is used in the encoding of the second dependency representation.

In some embodiments the method comprises selecting for transmission the first dependency representation or the second dependency representation or both the first and the second dependency representation.

In some embodiments the first view is non-scalably encoded, and the second view is spatially scalably encoded.

In some embodiments a maximum dependency indication value indicative of a number of scalability layers in the second view is included in the bitstream.

In some embodiments a first maximum dependency indication value indicative of a number of scalability layers in the first view is included in the bitstream, and a second maximum dependency indication value indicative of a number of scalability layers in the second view is included in the bitstream.

In some embodiments a spatial resolution of the first uncompressed picture and a spatial resolution of the second uncompressed picture are the same.

In some embodiments a spatial resolution of the first uncompressed picture and a spatial resolution of the first dependency representation are the same.

In some embodiments a spatial resolution of the first dependency representation and a spatial resolution of the second dependency representation are different.

According to a second embodiment there is provided an apparatus comprising:

an encoder configured for encoding the first uncompressed picture of a first view;

a reconstructor configured for reconstructing a first decoded picture on the basis of the encoding of the first uncompressed picture;

a sampler configured for resampling at least a part of the first decoded picture into a first resampled decoded picture; and

said encoder being further configured for

encoding a second uncompressed picture of a second view as a first dependency representation by using the first resampled decoded picture as a prediction reference, and

encoding a second dependency representation by using the first decoded picture as a prediction reference and the first dependency representation in the encoding of the second dependency representation.

In some embodiments the apparatus comprises a selector for selecting for transmission the first dependency representation or the second dependency representation or both the first and the second dependency representation.

In some embodiments the encoder configured for non-scalably encoding the first view, and for spatially scalably encoding the second view.

In some embodiments the encoder is configured for setting a view_resolution_change_property value indicative of a change in a resolution of the first view or the second view.

In some embodiments the encoder is configured for including a maximum dependency indication value indicative of a number of scalability layers in the second view in the bitstream.

In some embodiments a spatial resolution of the first uncompressed picture and a spatial resolution of the second uncompressed picture are the same.

In some embodiments a spatial resolution of the first uncompressed picture and a spatial resolution of the first dependency representation are the same.

In some embodiments a spatial resolution of the first dependency representation and a spatial resolution of the second dependency representation are different.

According to a third embodiment there is provided an apparatus comprising:

a processor; and

a memory unit operatively connected to the processor and including:

computer code configured to:

encode a first uncompressed picture of a first view;

reconstruct a first decoded picture on the basis of the encoding of the first uncompressed picture;

resample at least a part of the first decoded picture into a first resampled decoded picture; and

encode a second uncompressed picture of a second view as a first dependency representation and a second dependency representation,

wherein the first resampled decoded picture is used as a prediction reference for the encoding of the first dependency representation;

the first decoded picture is used as a prediction reference for the encoding of the second dependency representation; and

the first dependency representation is used in the encoding of the second dependency representation.

According to a fourth embodiment there is provided a method for decoding a multiview video bitstream comprising a first view component of a first view and a second view component of a second view, the method comprising:

decoding the first view component into a first decoded picture;

determining a spatial resolution of the first view component and a spatial resolution of the second view component;

on the basis of the spatial resolution of the first view component being different from the spatial resolution of the second view component:

resampling at least a part of the first decoded picture into a first resampled decoded picture;

decoding the second view component using the first resampled decoded picture as a prediction reference.

In some embodiments the method comprises examining an indication indicative of a change in a spatial resolution of said first view or said second view, and resampling at least a part of the first decoded picture if said indication indicates a change in the spatial resolution.

In some embodiments the method comprises comparing the difference between the spatial resolution of the first view component and the resolution of the second view component, and adjusting said resampling on the basis of the difference between the spatial resolutions.

In some embodiments the bitstream comprises at least two different dependency representations of the second view, each dependency representation provided with a dependency indication, wherein the dependency representation with the highest value for dependency indication is decoded.

According to a fifth embodiment there is provided an apparatus comprising:

a decoder configured for decoding a first view component of a first view into a first decoded picture;

a determining element configured for determining a spatial resolution of the first view component being different from a spatial resolution of a second view component of a second view;

a sampler configured for resampling at least a part of the first decoded picture into a first resampled decoded picture when the spatial resolution of the first view component differs from the spatial resolution of the second view component; and

said decoder being further configured for decoding the second view component using the first resampled decoded picture as a prediction reference.

In some embodiments the apparatus comprises an examining element configured for examining an indication indicative of a change in a spatial resolution of said first view or said second view, wherein said sampler is configured for resampling at least a part of the first decoded picture if said indication indicates a change in the spatial resolution.

In some embodiments the apparatus comprises a comparator configured for comparing the difference between the spatial resolution of the first view component and the resolution of the second view component, wherein said sampler is configured for adjusting said resampling on the basis of the difference between the spatial resolutions.

In some embodiments the bitstream comprises at least two different dependency representations of the second view, each dependency representation provided with a dependency indication, wherein the decoder is configured for decoding the dependency representation with the highest value for dependency indication.

According to a sixth embodiment there is provided an apparatus comprising:

a processor; and

a memory unit operatively connected to the processor and including

computer code configured to:

decode a first view component of a first view into a first decoded picture;

determine a spatial resolution of the first view component and a spatial resolution of a second view component of a second view;

on the basis of the spatial resolution of the first view component being different from the spatial resolution of the second view component:

resample at least a part of the first decoded picture into a first resampled decoded picture;

decode the second view component using the first resampled decoded picture as a prediction reference.

According to a seventh embodiment there is provided a computer readable storage medium stored with code thereon for use by an apparatus, which when executed by a processor, causes the apparatus to perform:

encode a first uncompressed picture of a first view;

reconstruct a first decoded picture on the basis of the encoding of the first uncompressed picture;

resample at least a part of the first decoded picture into a first resampled decoded picture; and

encode a second uncompressed picture of a second view as a first dependency representation and a second dependency representation,

wherein the code, which when executed by a processor, further causes the apparatus to:

use the first resampled decoded picture as a prediction reference for the encoding of the first dependency representation;

use the first decoded picture as a prediction reference for the encoding of the second dependency representation; and

use the first dependency representation in the encoding of the second dependency representation.

According to an eighth embodiment there is provided a computer readable storage medium stored with code thereon for use by an apparatus, which when executed by a processor, causes the apparatus to perform:

decode a first view component of a first view into a first decoded picture;

determine a spatial resolution of the first view component and a spatial resolution of a second view component of a second view;

on the basis of the spatial resolution of the first view component being different from the spatial resolution of the second view component:

resample at least a part of the first decoded picture into a first resampled decoded picture;

decode the second view component using the first resampled decoded picture as a prediction reference.

According to a ninth embodiment there is provided at least one processor and at least one memory, said at least one memory stored with code thereon, which when executed by said at least one processor, causes an apparatus to perform:

encode a first uncompressed picture of a first view;

reconstruct a first decoded picture on the basis of the encoding of the first uncompressed picture;

resample at least a part of the first decoded picture into a first resampled decoded picture; and

encode a second uncompressed picture of a second view as a first dependency representation and a second dependency representation,

wherein the code, which when executed by a processor, further causes the apparatus to:

use the first resampled decoded picture as a prediction reference for the encoding of the first dependency representation;

use the first decoded picture as a prediction reference for the encoding of the second dependency representation; and

use the first dependency representation in the encoding of the second dependency representation.

According to a tenth embodiment there is provided at least one processor and at least one memory, said at least one memory stored with code thereon, which when executed by said at least one processor, causes an apparatus to perform:

decode a first view component of a first view into a first decoded picture;

determine a spatial resolution of the first view component and a spatial resolution of a second view component of a second view;

on the basis of the spatial resolution of the first view component being different from the spatial resolution of the second view component:

resample at least a part of the first decoded picture into a first resampled decoded picture;

decode the second view component using the first resampled decoded picture as a prediction reference.

According to an eleventh embodiment there is provided an apparatus comprising:

means for encoding a first uncompressed picture of a first view;

means for reconstructing a first decoded picture on the basis of the encoding of the first uncompressed picture;

means for resampling at least a part of the first decoded picture into a first resampled decoded picture; and

means for encoding a second uncompressed picture of a second view as a first dependency representation by using the first resampled decoded picture as a prediction reference, and

means for encoding a second dependency representation by using the first decoded picture as a prediction reference and the first dependency representation in the encoding of the second dependency representation.

According to a twelfth embodiment there is provided an apparatus comprising:

means for decoding a first view component of a first view into a first decoded picture;

means for determining a spatial resolution of the first view component being different from a spatial resolution of a second view component of a second view;

means for resampling at least a part of the first decoded picture into a first resampled decoded picture when the spatial resolution of the first view component differs from the spatial resolution of the second view component; and

means for decoding the second view component using the first resampled decoded picture as a prediction reference.

What we claim is:

1. A method for encoding a first uncompressed picture of a first view and a second uncompressed picture of a second view into a bitstream comprising:
encoding the first uncompressed picture;
reconstructing a first decoded picture on the basis of the encoding of the first uncompressed picture;
resampling at least a part of the first decoded picture into a first resampled decoded picture; and
encoding the second uncompressed picture as a first dependency representation and a second dependency representation,
wherein the first resampled decoded picture is used as prediction reference for the encoding of the first dependency representation;
the first decoded picture is used as prediction reference for the encoding of the second dependency representation; and
the first dependency representation is used in the encoding of the second dependency representation.

2. The method according to claim 1 further comprising selecting for transmission the first dependency representation or the second dependency representation or both the first and the second dependency representation.

3. The method according to claim 1 comprising non-scalably encoding the first view, and spatially scalably encoding the second view.

4. The method according to claim 1 further comprising including in the bitstream a first maximum dependency indication value indicative of a number of scalability layers in the first view; and including in the bitstream a second maximum dependency indication value indicative of a number of scalability layers in the second view.

5. The method according to claim 1, wherein the first resampled decoded picture is used as prediction reference for the encoding of the first dependency representation in inter-view prediction; and
the first decoded picture is used as prediction reference for the encoding of the second dependency representation in inter-view prediction.

6. The method according to claim 1, wherein the first dependency representation is used in the encoding of the second dependency representation through an inter-layer prediction mechanism.

7. An apparatus comprising:
an encoder configured for encoding the first uncompressed picture of a first view;
a reconstructor configured for reconstructing a first decoded picture on the basis of the encoding of the first uncompressed picture;
a sampler configured for resampling at least a part of the first decoded picture into a first resampled decoded picture; and
said encoder being further configured for
encoding a second uncompressed picture of a second view as a first dependency representation by using the first resampled decoded picture as prediction reference, and
encoding a second dependency representation by using the first decoded picture as prediction reference and the first dependency representation in the encoding of the second dependency representation.

8. The apparatus according to claim 7, further comprising a selector for selecting for transmission the first dependency representation or the second dependency representation or both the first and the second dependency representation.

9. The apparatus according to claim 7, wherein the encoder is configured for non-scalably encoding the first view, and for spatially scalably encoding the second view.

10. The apparatus according to claim 7, wherein the encoder is configured for using the first resampled decoded picture as prediction reference for the encoding of the first dependency representation in inter-view prediction; and using the first decoded picture as prediction reference for the encoding of the second dependency representation in inter-view prediction.

11. The apparatus according to claims 7, wherein the encoder is configured for using the first dependency representation in the encoding of the second dependency representation through an inter-layer prediction mechanism.

12. An apparatus comprising:
a processor; and
a memory unit operatively connected to the processor and including:
computer code configured to:
encode a first uncompressed picture of a first view;
reconstruct a first decoded picture on the basis of the encoding of the first uncompressed picture;
resample at least a part of the first decoded picture into a first resampled decoded picture; and
encode a second uncompressed picture of a second view as a first dependency representation and a second dependency representation,
wherein the first resampled decoded picture is used as prediction reference for the encoding of the first dependency representation;
the first decoded picture is used as prediction reference for the encoding of the second dependency representation; and
the first dependency representation is used in the encoding of the second dependency representation.

13. A method for decoding a multiview video bitstream comprising a first view component of a first view and a second view component of a second view, the method comprising:
decoding the first view component into a first decoded picture;
determining a spatial resolution of the first view component and a spatial resolution of the second view component;
on the basis of the spatial resolution of the first view component being different from the spatial resolution of the second view component:
resampling at least a part of the first decoded picture into a first resampled decoded picture;
decoding the second view component using the first resampled decoded picture as prediction reference.

14. The method according to claim 13 further comprising examining an indication indicative of a change in a spatial resolution of said first view or said second view, and resampling at least a part of the first decoded picture if said indication indicates a change in the spatial resolution.

15. The method according to claim 13 further comprising comparing the difference between the spatial resolution of the first view component and the resolution of the second view component, and adjusting said resampling on the basis of the difference between the spatial resolutions.

16. The method according to claim 15, wherein the bitstream comprises a maximum dependency indication value; and wherein the method further comprises determining that the first view component being different from the spatial resolution of the second view component when the highest dependency indication of the second view being less than the maximum dependency indication value.

17. The method according to claim 13, wherein the second view component comprises at least one dependency representation, each of the at least one dependency representation comprises a dependency indication, wherein the method further comprises decoding a dependency representation with the highest value for dependency indication.

18. An apparatus comprising:
a decoder configured for decoding a first view component of a first view into a first decoded picture;
a determining element configured for determining a spatial resolution of the first view component being different from a spatial resolution of a second view component of a second view;
a sampler configured for resampling at least a part of the first decoded picture into a first resampled decoded picture when the spatial resolution of the first view component differs from the spatial resolution of the second view component; and
said decoder being further configured for decoding the second view component using the first resampled decoded picture as prediction reference.

19. The apparatus according to claim 18 further comprising an examining element configured for examining an indication indicative of a change in a spatial resolution of said first view or said second view, wherein said sampler is configured for resampling at least a part of the first decoded picture if said indication indicates a change in the spatial resolution.

20. The apparatus according to claim 18 further comprising a comparator configured for comparing the difference between the spatial resolution of the first view component and the resolution of the second view component, wherein said sampler is configured for adjusting said resampling on the basis of the difference between the spatial resolutions.

21. The apparatus according to claim 18, wherein the bitstream comprises at least two different dependency representations of the second view, each dependency representation provided with a dependency indication, wherein the decoder is configured for decoding the dependency representation with the highest value for dependency indication.

22. An apparatus comprising:
a processor; and
a memory unit operatively connected to the processor and including
computer code configured to:
decode a first view component of a first view into a first decoded picture;
determine a spatial resolution of the first view component and a spatial resolution of a second view component of a second view;
on the basis of the spatial resolution of the first view component being different from the spatial resolution of the second view component:
resample at least a part of the first decoded picture into a first resampled decoded picture;
decode the second view component using the first resampled decoded picture as prediction reference.

23. A computer readable storage medium stored with code thereon for use by an apparatus, which when executed by a processor, causes the apparatus to perform:
encode a first uncompressed picture of a first view;
reconstruct a first decoded picture on the basis of the encoding of the first uncompressed picture;
resample at least a part of the first decoded picture into a first resampled decoded picture; and
encode a second uncompressed picture of a second view as a first dependency representation and a second dependency representation,
wherein the code, which when executed by a processor, further causes the apparatus to:
use the first resampled decoded picture as prediction reference for the encoding of the first dependency representation;
use the first decoded picture as prediction reference for the encoding of the second dependency representation; and
use the first dependency representation in the encoding of the second dependency representation.

24. A computer readable storage medium stored with code thereon for use by an apparatus, which when executed by a processor, causes the apparatus to perform:
decode a first view component of a first view into a first decoded picture;
determine a spatial resolution of the first view component and a spatial resolution of a second view component of a second view;
on the basis of the spatial resolution of the first view component being different from the spatial resolution of the second view component:
resample at least a part of the first decoded picture into a first resampled decoded picture;
decode the second view component using the first resampled decoded picture as prediction reference.
